(19) United States
(12) Patent Application Publication
(10) Pub. No.: US 2026/0131316 A1
(43) Pub. Date: May 14, 2026

(54) BINARY COPPER-PALLADIUM ALLOY THIN FILM CATALYST AND METHOD OF PREPARING THE CATALYST

(71) Applicant: KING FAHD UNIVERSITY OF PETROLEUM AND MINERALS, Dhahran (SA)

(72) Inventors: Muhammad Ali EHSAN, Dhahran (SA); Abbas Saeed HAKEEM, Dhahran (SA)

(73) Assignee: KING FAHD UNIVERSITY OF PETROLEUM AND MINERALS, Dhahran (SA)

(21) Appl. No.: 18/943,385

(22) Filed: Nov. 11, 2024

(51) Int. Cl. B01J 23/89; B01J 21/18; B01J 35/33; B01J 35/50; B01J 37/02

(52) U.S. Cl. CPC B01J 23/8926; B01J 21/18; B01J 35/33; B01J 35/50; B01J 37/0238

(57) ABSTRACT

A catalyst includes a graphite substrate and a thin film of copper-palladium alloy disposed on the graphite substrate. The copper-palladium alloy conforms to a formula of Cu₁₋ₓPdₓ, where x is about 0.4. The thin film includes conical structures that has a length of 1-20 μm, and the conical structures having a pine-tree shape has tiers of sheet-like branches. An electrode includes the catalyst and no binder.

### STATEMENT OF ACKNOWLEDGEMENT

Support provided by the Interdisciplinary Research Center for Hydrogen Technologies and Carbon Management (IRC-HTCM) and Deanship of Research Oversight and Coordination (DROC), King Fahd University of Petroleum and Minerals (KFUPM), Saudi Arabia, is gratefully acknowledged.

### STATEMENT REGARDING PRIOR DISCLOSURE BY THE INVENTORS

Aspects of the present disclosure are described in “Facile fabrication of binary copper-palladium alloy thin film catalysts for exceptional hydrogen evolution performance” Materials Advances 2024, 5, 8086-8096, which is incorporated herein by reference in its entirety.

### BACKGROUND

### Technical Field

The present disclosure is directed to a copper-palladium alloy, a catalyst based on a binary copper-palladium alloy thin film and a method of preparing the catalyst.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Efficient and sustainable energy solutions are key to addressing climate change and fossil fuel depletion. Hydrogen (H₂) is a promising renewable energy source due to its high calorific value and environmentally benign properties, but hydrogen extraction via fossil fuels may emit carbon dioxide (CO₂), undermining the renewable nature of hydrogen. In order to tackle such issues, electrochemical water splitting, particularly a hydrogen evolution reaction (HER) has been evaluated and HER may offer a cleaner alternative for hydrogen extraction. However, HER requires advanced catalysts for efficient H₂ production.

Platinum (Pt) is the most effective catalyst for the hydrogen evolution reaction (HER), but economical constraints pertaining to Pt and corrosion issues its limit large-scale use. Hence, alternative elements having properties like Pt, including high catalytic activity, electrical conductivity, and stability are required. Further, elements such as palladium (Pd), rhodium (Rh), rhenium (Re), and iridium (Ir), akin to Pt, have been researched in context of HER catalysis. As such, Pd-based nanomaterials have high catalytic activity and have become essential in various electrochemical processes, primarily due to their involvement in hydrogen-related reactions. Developing Pd-based catalysts involves alloying Pd with three-dimensional (3D) transition metals like Ni, Co, and Cu. The aforementioned approach reduces the usage of noble metals and fosters a synergistic interplay between alloying metals, redistributing charge density, adjusting surface and electronic properties, thereby enhancing the electrocatalytic traits of the alloy catalyst. Consequently, Pd alloys with binary and ternary compositions display an increased affinity for adsorbing substantial quantities of hydrogen from electrolytes, consistently demonstrating desirable performance in HER and achieving high current densities. A palladium-cobalt (PdCo) alloy encapsulated in nitrogen doped (N-doped) carbon (PdCo@CN) was produced by calcining Pd-doped metal-organic-frameworks (MOFs) under a N₂ atmosphere. The PdCo@CN catalyst exhibited high HER activity, a current density of 10 mA cm⁻² at only 80 mV (vs.RHE)), a Tafel slope of 31 millivolts per decade (mV dec⁻¹), and long-term stability in an acidic solution. Similarly, palladium-nickel (PdNi) alloy films fabricated via a chemical vapor deposition (CVD) approach demonstrated high efficiency in HER catalysis. PdNi alloy electrocatalyst achieved desirable current decade at an overpotential of about 20 mV, with a Tafel value of 50.2 mV dec⁻¹, and further exhibited high chemical and mechanical stability.

However, there is still a requirement for improving the design of Pd-M alloy catalysts with unique phases and distinct morphologies at scalable levels to further address the activity and durability issues of Pd-M catalysts. In this regard, fabricating thin film electrocatalyst on a conductive support through appropriate deposition techniques may expedite the HER kinetics. Typically, alloy catalysts are synthesized as powders and then converted into electrodes using chemical binders and reagents to ensure mechanical strength and adhesion to the support surface. The addition of binders may mask active sites of the catalyst and slow down the rate of electrochemical reaction and hence the HER activity.

Accordingly, it is one object of the present disclosure to provide a catalyst that may circumvent the drawbacks and limitations, such as low electrical conductivity, high costs, and poor stability, of catalysts known in the art.

### SUMMARY

In an exemplary embodiment, a catalyst is described. The catalyst includes a graphite substrate and a thin film of copper-palladium alloy disposed on the graphite substrate. The copper-palladium alloy conforms to a formula of Cu₁₋ₓPdₓ, where x is about 0.4. The thin film includes conical structures that have a length of 1-20 micrometer μm. The conical structures have a pine-tree shape that has tiers of sheet-like branches.

In some embodiments, the tiers are stacked in a longitudinal direction of the pine-tree shape, and the sheet-like branches are substantially perpendicular to the longitudinal direction of the pine-tree shape. Each tier includes a respective plurality of sheet-like branches arranged adjacent to each other.

In some embodiments, the sheet-like branches decrease in lateral dimensions along the longitudinal direction of the pine-tree shape from a wide end of the pine-tree shape to a narrow end of the pine-tree shape.

In some embodiments, the sheet-like branches are arranged in a whorled pattern, when viewed from the narrow end of the pine-tree shape.

In some embodiments, the narrow end of the pine-tree shape is a sharp point or a single smallest sheet-like branch.

In some embodiments, the narrow end of the pine-tree shape has a lateral dimension of 0.5 μm or less, and the wide end of the pine-tree shape has a lateral dimension of 1 μm or more and 10 μm or less.

In some embodiments, the thin film consists of a single-phase Cu₁₋ₓPdₓ alloy and includes no metallic copper and no metallic palladium.

In some embodiments, the thin film includes no copper oxide and no palladium oxide.

In some embodiments, the conical structures are oriented randomly on the graphite substrate.

In some embodiments, one or more of the conical structures are oriented perpendicular to the graphite substrate.

In some embodiments, the catalyst has an overpotential of 64 millivolt (mV) at a current density of 100 mAcm⁻², which is lower than those of pure palladium and pure copper.

In some embodiments, the catalyst has an overpotential of 137 mV at a current density of 1000 mAcm⁻², which is lower than those of pure palladium and pure copper.

In some embodiments, the catalyst has a Tafel slope of 28 mV/dec, which is lower than those of pure palladium and pure copper.

In some embodiments, the catalyst has a surface Gibbs free energy of −0.12 electronvolt (eV), which is closer to zero than those of pure palladium and pure copper.

In some embodiments, the catalyst has a charge-transfer resistance of 0.11 ohm centimeter square (Ωcm²), which is lower than those of pure palladium and pure copper.

In some embodiments, the catalyst is formed by executing an aerosol-assisted chemical vapor deposition (AACVD) process that includes converting a precursor solution into an aerosol mist by an ultrasonic humidifier. The precursor solution include copper acetylacetonate and palladium acetylacetonate. The process further includes directing the aerosol mist towards a graphite substrate placed in a furnace by a carrier gas containing hydrogen and nitrogen, and maintaining the graphite substrate at a temperature of 450° C.-550° C. to evaporate a solvent of the aerosol mist, decomposing the copper acetylacetonate and the palladium acetylacetonate, and forming the thin film on the graphite substrate to form the catalyst.

In some embodiments, an electrode is described. The electrode includes the catalyst and no binder.

In another exemplary embodiment, a method of preparing a catalyst is described. The method includes executing an aerosol-assisted chemical vapor deposition (AACVD) process. The AACVD process includes converting a precursor solution into an aerosol mist by an ultrasonic humidifier. The precursor solution includes copper acetylacetonate and palladium acetylacetonate. The AACVD process further includes directing the aerosol mist towards a graphite substrate placed in a furnace by a carrier gas containing hydrogen and nitrogen. The AACVD process further includes maintaining the graphite substrate at a temperature of 450° C.-550° C. so as to evaporate a solvent of the aerosol mist, decomposing the copper acetylacetonate and palladium acetylacetonate, and forming a thin film of copper-palladium alloy on the graphite substrate to form a catalyst including the thin film and the graphite substrate. The AACVD process further includes using the catalyst directly as an electrode without binding to another support surface or electrode surface.

In some embodiments, no structural directing reagent or template is used for forming the thin film of copper-palladium alloy on the graphite substrate.

In some embodiments, a deposition time of the AACVD process is at least 2 hours, and the temperature, at which the graphite substrate is maintained, is about 475° C.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings.

FIG. 1 is a schematic flow chart of a method of preparing a catalyst by executing an aerosol-assisted chemical vapor deposition (AACVD) process, according to certain embodiments.

FIG. 2 is a schematic illustration of a system for executing an AACVD process, according to certain embodiments.

FIG. 3 shows overlaid x-ray diffraction (XRD) patterns of monometallic Pd, Cu and binary Cu_{0.6}Pd_{0.4} alloy films prepared via the AACVD process, according to certain embodiments.

FIG. 4A shows scanning electron microscopy (SEM) images captured at different resolutions (e.g. 20 μm, 5 μm, and 1 μm) for a binary CuPd alloy grown on a graphite substrate after depositing for 1 h, according to certain embodiments.

FIG. 4B shows SEM images captured at different resolutions (e.g. 20 μm, 5 μm, and 1 μm) for a binary CuPd alloy grown on a graphite substrate after depositing for 2 h, according to certain embodiments.

FIG. 4C shows SEM images captured at different resolutions (e.g. 20 μm, 5 μm, and 1 μm) for monometallic Cu grown on a graphite substrate, according to certain embodiments.

FIG. 4D shows SEM images captured at different resolutions (e.g. 20 μm, 5 μm, and 1 μm) for monometallic Pd grown on a graphite substrate, according to certain embodiments.

FIG. 5A shows an energy dispersive x-ray (EDX) spectrum and an electron image of monometallic Cu, according to certain embodiments.

FIG. 5B shows an EDX spectrum and an electron image of monometallic Pd, according to certain embodiments.

FIG. 5C shows an EDX spectrum and an electron image of a binary CuPd (Cu_{0.6}Pd_{0.4}-1h) alloy, according to certain embodiments.

FIG. 5D shows an EDX spectrum and an electron image of a binary CuPd (Cu_{0.6}Pd_{0.4}-2h) alloy, according to certain embodiments.

FIG. 6A shows EDX mapping of binary CuPd (Cu_{0.6}Pd_{0.4}-1h) alloy samples, according to certain embodiments.

FIG. 6B shows EDX mapping of binary CuPd (Cu_{0.6}Pd_{0.4}-2h) alloy samples, according to certain embodiments.

FIG. 7 shows an x-ray photoelectron spectroscopy (XPS) survey scan spectrum of a CuPd alloy, according to certain embodiments.

FIG. 8A shows a high resolution XPS spectrum of Pd 3d in a CuPd alloy, according to certain embodiments.

FIG. 8B shows a high resolution XPS spectrum of Cu 2p in a CuPd alloy, according to certain embodiments.

FIG. 9A shows coefficient of variation (CV) analysis of a binary CuPd alloy electrocatalyst performed at a scan speed of 50 mVs⁻¹ in 0.5 M H₂SO₄ electrolyte fabricated for 1 h, according to certain embodiments.

FIG. 9B shows CV analysis of a binary CuPd alloy electrocatalyst performed at a scan speed of 50 mV s⁻¹ in 0.5 M H₂SO₄ electrolyte fabricated for 2 h, according to certain embodiments.

FIG. 9C shows comparison of 150^{th} CVs of the alloy samples of CuPd-1h and CuPd-2h, according to certain embodiments.

FIG. 10A shows electrochemical HER measurements of different electrocatalysts in the form of LSV curves in 0.5 M H₂SO₄ solution, according to certain embodiments.

FIG. 10B shows electrochemical HER measurements of different electrocatalysts in the form of enlarged LSV curves in 0.5 M H₂SO₄ solution, according to certain embodiments.

FIG. 10C shows electrochemical HER measurements of different electrocatalysts in the form of overpotential (η) comparison at different current densities 100 and 1000 mAcm⁻² in 0.5 M H₂SO₄ solution, according to certain embodiments.

FIG. 10D shows electrochemical HER measurements of different electrocatalysts in the form of Tafel slopes derived from corresponding LSV curves in 0.5 M H₂SO₄ solution, according to certain embodiments.

FIG. 10E shows electrochemical HER measurements of different electrocatalysts in the form of EIS Nyquist plots in 0.5 M H₂SO₄ solution, according to certain embodiments.

FIG. 10F shows electrochemical HER measurements of different electrocatalysts in the form of TOF curves in 0.5 M H₂SO₄ solution, according to certain embodiments.

FIG. 11A shows electrochemical surface area (ECSA) measurements involving CVs recorded at different scan rates in non-Faradic region of CuPd-1h catalysts, according to certain embodiments.

FIG. 11B shows ECSA measurements involving CVs recorded at different scan rates in non-Faradic region of CuPd-2h catalysts, according to certain embodiments.

FIG. 11C is a graph showing capacitive current densities of CuPd-1h catalysts plotted against a scan rate, according to certain embodiments.

FIG. 11D is a graph showing capacitive current densities of CuPd-2h catalysts plotted against a scan rate, according to certain embodiments.

FIG. 12A shows the Choronopotentiometric stability test of a binary CuPd-2h catalyst, according to certain embodiments.

FIG. 12B shows comparison of polarization curves before and after 24 h stability test, according to certain embodiments.

FIG. 13A, FIG. 13 B and FIG. 13C show SEM images and elemental mapping of CuPd-2h electrocatalyst after the stability test, according to certain embodiments.

FIG. 13D shows EDX analysis to determine the elemental concentrations of Pd and Cu, respectively, according to certain embodiments.

FIG. 14A shows a free-energy diagram for hydrogen evolution on Pd, Cu and PdCu surfaces, according to certain embodiments.

FIG. 14B shows a top view of hydrogen adsorption on a PdCu surface, according to certain embodiments.

FIG. 14C shows a side view of hydrogen adsorption on a PdCu surface, according to certain embodiments.

### DETAILED DESCRIPTION

In the drawings, like reference numerals designate identical or corresponding parts throughout the several views. Further, as used herein, the words “a”, “an” and the like generally carry a meaning of “one or more”, unless stated otherwise.

Furthermore, the terms “approximately,” “approximate”, “about” and similar terms generally refer to ranges that include the identified value within a margin of 20%, 10%, or preferably 5%, and any values therebetween.

As used herein, the term “aerosol-assisted chemical vapor deposition” (AACVD) refers to a process in which a precursor solution is aerosolized, and aerosol droplets are carried to a heated substrate by a carrier gas. Upon reaching the substrate, the precursor undergoes thermal decomposition or reaction, resulting in the deposition of a thin film. This method allows for the control of film composition and thickness, making it suitable for creating uniform coatings of materials such as metals, alloys, and oxides on various substrates.

As used herein, the term “alloy” refers to a material composed of two or more elements, at least one of which is a metal. Alloys are formed by melting and mixing these elements, resulting in a substance with enhanced properties, such as improved strength, corrosion resistance, or conductivity, compared to the individual components. The elements in an alloy can form various structures, including solid solutions or intermetallic compounds, depending on their composition and the specific conditions of alloy formation.

As used herein, the term “aerosol mist” refers to a suspension of fine liquid or solid particles dispersed in a gas, typically air. In processes like AACVD, the aerosol mist carries one or more precursor materials in the form of droplets or particles, which are then delivered to a substrate. Upon deposition, the precursors undergo chemical reactions, often facilitated by heat, to form thin films or coatings on the substrate surface. The fine particle size in the mist ensures uniform distribution and controlled deposition of the material.

As used herein, the term “carrier gas” refers to an inert or reactive gas used to transport one or more vaporized precursor materials or aerosol mist to a deposition zone in processes such as chemical vapor deposition (CVD) or aerosol-assisted chemical vapor deposition (AACVD). The carrier gas ensures efficient delivery and uniform dispersion of the precursor materials to the substrate surface, where the desired chemical reactions take place, leading to the formation of thin films or coatings. Common carrier gases include nitrogen, argon, and hydrogen, depending on the specific application and the chemical nature of the precursors.

As used herein, the term “binder” refers to a substance used to hold or adhere particles of a material together, providing structural support and mechanical stability to an electrode. In electrochemical applications, binders are commonly used to help attach the active catalyst material to a substrate or electrode, ensuring good contact and cohesion without compromising the electrical conductivity. Typical binders include materials like polyvinylidene fluoride (PVDF), polytetrafluoroethylene (PTFE), and Nafion, which provide flexibility and adhesion while maintaining chemical and thermal stability in the operating environment.

As used herein, the term “catalyst” refers to a substance that increases the rate of a chemical reaction without itself undergoing permanent chemical change. In electrochemical reactions, such as the hydrogen evolution reaction (HER), a catalyst lowers the activation energy required for the reaction, thereby improving efficiency. Catalysts are often composed of metals, alloys, or other materials that facilitate charge transfer and reaction kinetics at the surface, making them essential for processes like energy conversion and storage in fuel cells, electrolyzers, and batteries.

As used herein, the term “charge-transfer resistance” refers to a measure of the resistance encountered during the transfer of charge between an electrode and an electrolyte in an electrochemical reaction. It is a parameter in determining the efficiency of electrochemical processes, such as the hydrogen evolution reaction (HER). Lower charge-transfer resistance indicates more efficient electron movement, resulting in faster reaction kinetics and improved catalytic performance. This resistance is often analyzed using electrochemical techniques like electrochemical impedance spectroscopy (EIS).

As used herein, the term “surface Gibbs free energy” refers to a thermodynamic quantity that represents the energy associated with the surface of a material. It is the energy required to create a new surface or maintain an existing one, and it influences various surface-related phenomena such as adsorption, catalytic activity, and surface tension. A lower surface Gibbs free energy typically indicates greater stability of the surface, which can affect processes like catalysis and material reactivity in electrochemical systems.

As used herein, the term “Tafel slope” refers to a parameter derived from the Tafel equation, which relates the rate of an electrochemical reaction to the applied overpotential. It represents the change in the overpotential required to increase the current density by an order of magnitude. The Tafel slope is typically expressed in millivolts per decade (mV/dec) and provides insights into the kinetics of electrochemical reactions, such as hydrogen evolution or oxygen reduction. A lower Tafel slope indicates more efficient charge transfer and faster reaction kinetics.

As used herein, the term “overpotential” refers to the extra potential or voltage required beyond the thermodynamic equilibrium potential to drive an electrochemical reaction at a desired rate. It represents the energy losses during a reaction, such as in processes like hydrogen evolution or oxygen reduction, and is a key factor in determining the efficiency of electrochemical systems. Overpotential can result from factors like slow reaction kinetics, mass transport limitations, or charge transfer resistance, and is typically measured in millivolts (mV). Lower overpotentials indicate more efficient reactions.

As used herein, the term “current density” refers to the amount of electric current flowing per unit area of an electrode surface in an electrochemical system. It is typically expressed in units of milliamperes per square centimeter (mA/cm²). It is a parameter in evaluating the performance of electrochemical reactions, such as those occurring in fuel cells or electrolyzers. Higher current densities indicate a greater rate of electron transfer and reaction kinetics, which can enhance the efficiency of the electrochemical process. Current density is influenced by factors such as the electrode material, reaction conditions, and the presence of catalysts.

Aspects of this disclosure are directed to a method of preparing a catalyst using an aerosol-assisted chemical vapor deposition (AACVD) process. One advantage of the AACVD approach is its ability to grow novel features directly onto the substrate surface, even without structural directing reagents or templates, within a remarkably short processing time.

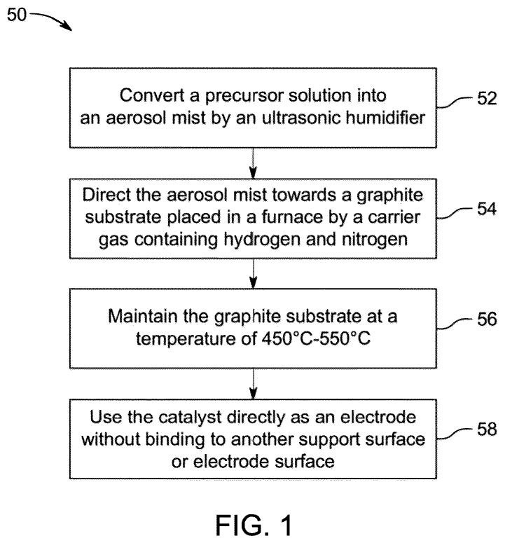

FIG. 1A illustrates a schematic flow chart of a method 50 of preparing a catalyst by executing an aerosol-assisted chemical vapor deposition (AACVD) process. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At step 52, the method 50 includes converting a precursor solution into an aerosol mist by an ultrasonic humidifier. The precursor solution includes metal-organic compounds dissolved in a solvent mixture. The metal-organic compounds can for example include copper acetylacetonate (Cu(acac)₂) and palladium acetylacetonate Pd(acac)₂) which serve as precursor for copper and palladium elements for thin-film formation. Alternatively or additionally, other metal-organic compounds such as copper nitrate (Cu(NO₃)₂), copper chloride (CuCl₂), copper formate (Cu(HCOO)₂), copper sulfate (CuSO₄), and copper methoxide (Cu(OCH₃)₂) may be used as a copper precursor; and palladium chloride (PdCl₂), palladium nitrate (Pd(NO₃)₂), palladium acetate (Pd(OAc)₂), palladium bromide (PdBr₂), and palladium methoxide (Pd(OCH₃)₂), may be used as a palladium precursor. The present disclosure will be focused on Cu(acac)₂ and Pd(acac)₂ merely for illustrative purposes and is not limiting.

In a preferred embodiment, the molar concentration ratio of copper acetylacetonate (Cu(acac)₂) and palladium acetylacetonate (Pd(acac)₂) may be in the range of 1:5 to 5:1, preferably 4:1 to 1:4, preferably 3:1 to 1:3, preferably 1:2 to 2:1, preferably 1:1. In a preferred embodiment, the molar concentration ratio of copper acetylacetonate (Cu(acac)₂) and palladium acetylacetonate (Pd(acac)₂) is 1:1.

The solvent mixture includes toluene and chloroform. Alternatively or additionally, the solvent mixture may include other solvents, such as acetone, ethanol, hexane, methanol, dichloromethane, diethyl ether, cyclohexane, acetonitrile, isopropanol, and ethyl acetate, which may also be used alone or in combination. In some embodiments, the volume ratio of toluene and chloroform in the solvent mixture may be 5:1 to 1:5, preferably 4:1 to 1:4, preferably 3:1 to 1:3, preferably 1:2 to 2:1, preferably 1:1. In a preferred embodiment, the volume ratio of toluene and chloroform in the solvent mixture is about 2:1 to 2.5:1.

Converting the precursor solution into the aerosol mist is typically performed via an AACVD process using the ultrasonic humidifier. The ultrasonic humidifier produces high-frequency sound waves, creating vibrations within the precursor solution. The precursor solution disintegrates the liquid into an evenly distributed mist of tiny aerosol droplets. The fine mist can provide a steady supply of one or more precursor materials to the deposition zone for obtaining a uniform thin film. Each microscopic droplet in the aerosol mist contains a specific proportion of the copper and palladium compounds dissolved in the precursor solution.

At step 54, the method 50 includes directing the aerosol mist towards a graphite substrate placed in a furnace by a carrier gas containing hydrogen and nitrogen. Alternatively or additionally, the carrier gas may include, but is not limited to, argon, helium, neon, xenon, carbon dioxide, methane, ethane, propane, butane, acetylene, ammonia, water vapor, oxygen, sulfur hexafluoride, and/or hydrogen sulfide. In a preferred embodiment, the carrier gas consists of hydrogen and nitrogen. The carrier gas serves several functions, e.g. facilitating the efficient transport of the aerosolized precursor materials to the substrate. In this setup, hydrogen plays at least a dual role: it acts as a reducing agent that enhances the decomposition of the metal precursors, promoting the formation of metallic films on the substrate, and it also helps prevent oxidation during the deposition process. Nitrogen functions as an inert component and helps maintain a stable environment, reducing the risk of unwanted chemical reactions that could compromise the quality of the deposited films.

In some embodiments, H₂ is present at a concentration of 1-11 vt. %, preferably 3-9 vt. %, preferably 5-7 vt. % based on a total volume of the carrier gas. In a preferred embodiment, the carrier gas included 5% H₂ balanced with N₂ gas.

In some embodiment, the carrier gas may have a flow rate of 10-300 cm³/min, preferably 50-200 cm³/min, preferably 75-150 cm³/min. In a preferred embodiment, the flow rate of carrier gas is 100 cm³/min.

In some embodiments, the substrate may be smooth and not porous. As discussed earlier, the substrate may include graphite. Alternatively or additionally, the substrate may include silicon, glass, quartz, aluminum, copper, sapphire, silicon carbide, titanium, stainless steel, and/or polystyrene. In the preferred embodiment, the substrate used is graphite. The graphite substrate serves as a surface onto which the thin films are deposited. Graphite is chosen for its excellent thermal conductivity, which allows it to maintain a uniform temperature during the deposition process, which is essential for consistent film formation. Additionally, the inert nature of graphite reduces chemical interactions with the precursor materials, ensuring that the focus remains on the desired deposition of copper and palladium.

To enhance the adhesion and the overall quality of the deposited material on the substrate, in some embodiments, the substrate, preferably the graphite strips, may be cleaned with a solvent to remove impurities that may interfere with the AACVD process. In a preferred embodiment, the solvent may be ethanol, acetone, isopropanol, methanol, n-hexane, dichloromethane, toluene, chloroform, water, ethyl acetate, butanol, dimethyl sulfoxide (DMSO), acetonitrile, ammonia solution, hydrochloric acid, propylene glycol, tetrahydrofuran (THF), or any combination thereof. In a preferred embodiment, the graphite strips are cleaned using acetone and ethanol solvents to obtain a substantially contaminant-free surface. In some embodiments, the graphite strips may be cleaned using ethanol, which effectively removes organic residues, oils, and dirt. Acetone is a powerful solvent that effectively eliminates more stubborn contaminants, including grease and any remaining residues from previous processes.

In some embodiments, graphite strips may have various dimensions such as 1×1 cm², 1×3 cm², 1×4 cm², 1×5 cm², 1×6 cm², 1×7 cm², 1×8 cm², 1×2 cm², etc. In a preferred embodiment, the graphite strips have dimensions of 1×2 cm².

At step 56, the method 50 includes maintaining the graphite substrate at a temperature of 400° C.-600° C., preferably 450° C.-550° C., preferably 475° C.-525° C., so as to evaporate a solvent of the aerosol mist, decompose the copper acetylacetonate and the palladium acetylacetonate, and form a thin film of copper-palladium alloy on the graphite substrate to form a catalyst including the thin film and the graphite substrate.

In some embodiments, the temperature at which the graphite substrate is maintained may range from 450° C. to 550° C., 450° C. to 500° C., 470° C. to 550° C., 490° C. to 550° C., 450° C. to 510° C., and 460° C. to 550° C. In a preferred embodiment, the graphite substrate is maintained at a temperature of 475° C. At 475° C., the solvent in the aerosol mist evaporates rapidly, ensuring the substrate remains free of excess liquid that could impede film formation. The elevated temperature also facilitates the thermal decomposition of the precursors, copper acetylacetonate and palladium acetylacetonate, breaking them down into their metallic constituents. As these precursors decompose, copper and palladium atoms (or ions or radicals) are released and migrate to the substrate surface, where they nucleate and grow into a coherent thin film. The formation of the copper-palladium alloy thin film on the graphite substrate can create a catalyst that leverages the unique properties of both metals. The thin film provides a high surface area for catalytic reactions, while the graphite substrate contributes to excellent thermal and electrical conductivity, enhancing the overall performance of the catalyst.

In some embodiments, the deposition time of the AACVD process may range from 1 to 12 hours, preferably 1.25 to 6 hours, preferably 1.5 to 3 hours, preferably 1.75 to 2.5 hours, preferably about 2 hours.

In some embodiments, the method of forming the copper-palladium alloy thin film on the graphite substrate involves using a structural directing reagent or template. Suitable examples of the structural directing reagent may include cetyltrimethylammonium bromide (CTAB), polyvinylpyrrolidone (PVP), sodium dodecyl sulfate (SDS), Pluronic P123, tetrapropylammonium hydroxide (TPAOH), ethylene glycol, polyethylene glycol (PEG), hexadecylamine (HDA), 1-octadecylamine, and Triton X-100. In a preferred embodiment, no structural directing reagent or template is used to form the thin film of copper-palladium alloy on the graphite substrate.

At step 58, the method 50 includes using the catalyst directly as an electrode without binding to another support surface or electrode surface. By using the catalyst directly, the active material is fully exposed, increasing its surface area, and enhancing the efficiency of electrochemical reactions, such as the hydrogen evolution reaction (HER). Additionally, this method reduces resistive losses and improves electron transfer between the catalyst and the electrolyte, contributing to better overall performance in energy conversion applications like fuel cells and electrolyzers.

In some embodiments, an electrode may incorporate a binder for support, including materials such as polyvinylidene fluoride (PVDF), Nafion, polytetrafluoroethylene (PTFE), carboxymethyl cellulose (CMC), polyethylene glycol (PEG), sodium alginate, polyvinyl alcohol (PVA), graphite oxide, xanthan gum, starch, ethylene glycol, polyacrylic acid (PAA), polyurethane, silicon rubber, and natural rubber. In a preferred embodiment, the electrode includes the catalyst and no binder.

A catalyst includes a graphite substrate that serves as a robust foundation for the catalytic process, providing excellent thermal and electrical conductivity. On this graphite substrate, a thin film of a copper-palladium alloy is applied for enhancing the catalyst's performance in electrochemical reactions, such as the hydrogen evolution reaction (HER). The copper-palladium alloy combines the desirable properties of both metals, allowing for improved catalytic activity and stability. The alloy's unique microstructure increases the surface area available for reactions, while the interaction between copper and palladium synergistically improves the electronic properties and facilitates better charge transfer and reaction kinetics.

In some embodiments, the copper-palladium alloy conforms to the formula Cu₁₋ₓPdₓ. The value of x in the Cu—Pd alloy formula may range from 0.1 to 0.5, with specific ranges including 0.1 to 0.2, 0.1 to 0.3, 0.1 to 0.4, 0.2 to 0.3, 0.2 to 0.5, and 0.3 to 0.4. In a preferred embodiment, the value of x is about 0.4.

The Cu—Pd alloy can be structurally characterized through X-ray diffraction (XRD), revealing distinct crystalline phases, including amorphous, orthorhombic, tetragonal, or rhombohedral structures. In a preferred embodiment, the thin film includes a single-phase Cu₁₋ₓPdₓ alloy that exhibits a cubic phase.

In some embodiments, crystalline peaks of metallic copper and metallic palladium may be observed, alongside the peaks corresponding to copper oxide and palladium oxide. In a preferred embodiment, no additional crystalline peaks, other than the single-phase Cu₁₋ₓPdₓ alloy phase, related to other possible phases of the CuPd alloy, metallic palladium, cobalt, or any of their oxide species are detected, thereby confirming the formation of a single-phase Cu_{0.6}Pd_{0.4} alloys.

The morphology of The Cu—Pd alloy composite can be structurally characterized using scanning electron microscopy (SEM) analysis. The alloy may exhibit a range of morphological shapes, including, but not limited to, nanocrystals, nanorectangles, nanotriangles, nanopentagons, nanohexagons, nanoprisms, nanodisks, nanocubes, nanoribbons, nanoblocks, nanobeads, nanoflakes, nanopowders, and nanoflowers, as well as mixtures thereof.

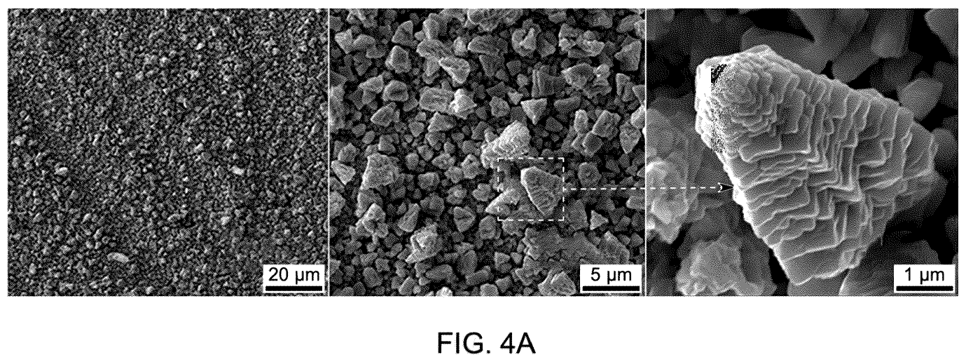

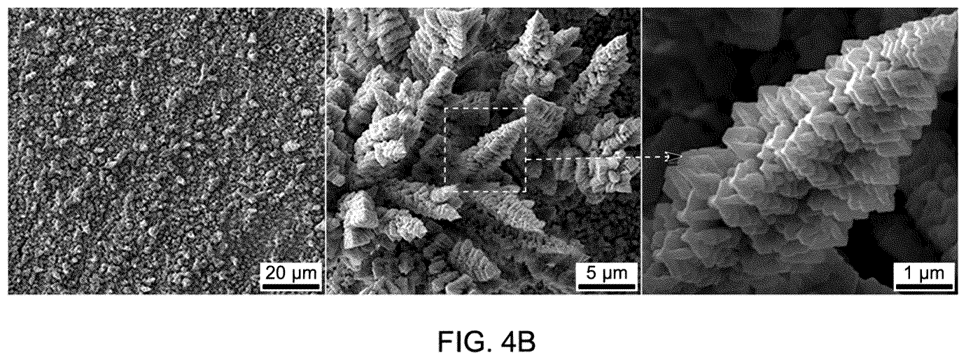

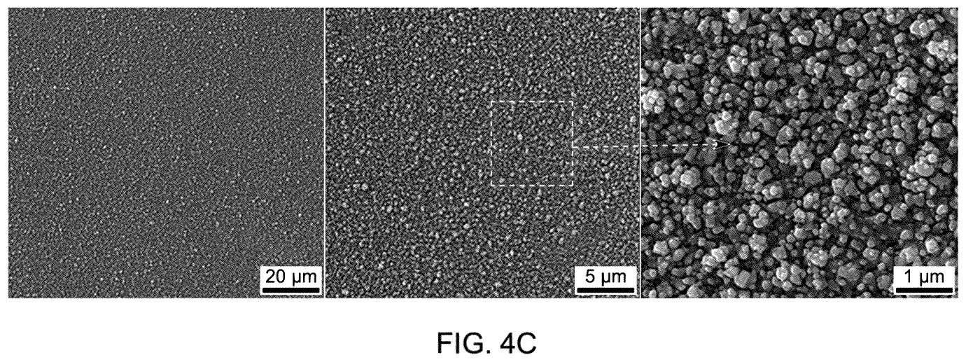

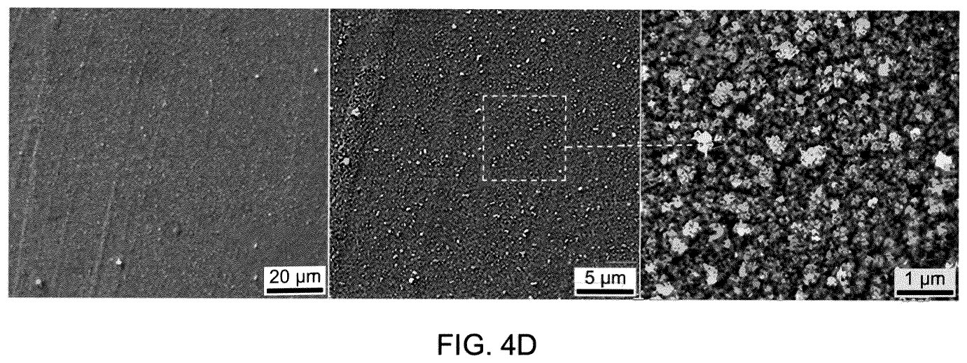

In some embodiments, the thin film includes conical structures that have a pine-tree shape that has tiers of sheet-like branches (see e.g. FIGS. 4A and 4B). The tiers can be stacked in a longitudinal direction of the pine-tree shape. The sheet-like branches can be substantially perpendicular to the longitudinal direction of the pine-tree shape. Each tier can include a respective plurality of sheet-like branches arranged adjacent to each other. The sheet-like branches can be arranged in a whorled pattern, when viewed from the narrow end of the pine-tree shape. The sheet-like branches may decrease in lateral dimensions along the longitudinal direction of the pine-tree shape from a wide end of the pine-tree shape to a narrow end of the pine-tree shape. The narrow end of the pine-tree shape can be a sharp point or a single smallest sheet-like branch.

In a preferred embodiment, the morphology (see e.g. FIG. 4A) of a binary CuPd alloy deposited for 1 h exhibits structures that extend upward from the plane of the graphite substrate along with the emergence of tower-like structures standing tall in a vertical orientation, adorned with continuous buds reminiscent of a Christmas tree.

In a preferred embodiment, the morphology (see e.g. FIG. 4B) of a binary CuPd alloy as the deposition time extends to 2 hours, there is an enhancement in the growth of the structures, leading to the appearance of clusters of tower-like objects, resembling a skyline seen from a bird's-eye view, with numerous skyscraper-like buildings. The conical structures are oriented randomly on the graphite substrate. One or more of the conical structures are oriented perpendicular to the graphite substrate. The conical structures have a pine-tree shape that has tiers of sheet-like branches.

In some embodiment, the thin film includes conical structures that may have lengths ranging from 1-20 μm, e.g. 1 μm, 10 μm, 8 μm, 6 μm, 5 μm, 16 μm, 18 μm, 15 μm, 20 μm or any values therebetween. In preferred embodiment, the thin film includes conical structures that have a length of about 5 μm.

In some embodiments, the tiers may be stacked in lateral, vertical, horizontal, radial, oblique, transverse, axial, diagonal, perpendicular, inclined directions of the pine tree. In a preferred embodiment, the tiers are stacked in a longitudinal direction of the pine tree shape.

In some embodiments, the sheet-like branches are substantially lateral, vertical, horizontal, radial, oblique, transverse, axial, diagonal, inclined, and parallel to the longitudinal direction of the pine-tree shape. In a preferred embodiment, the sheet-like branches are substantially perpendicular to the longitudinal direction of the pine-tree shape, and each tier includes a plurality of sheet-like branches arranged adjacent to each other.

In some embodiments, the narrow end of the pine-tree shape may have a lateral dimension of 0.5 μm or less, e.g. 0.4 μm, 0.3 μm, 0.2 μm, 0.1 μm, 0.25 μm, 0.35 μm, 0.45 μm or any values therebetween. The wide end of the pine-tree shape may have a lateral dimension of 1-10 μm, preferably 2-9 μm, preferably 3-8 μm, preferably 4-7 μm, preferably 5-6 μm.

In a preferred embodiment, the copper-palladium alloy sample deposited for 1 hour exhibits atomic percentages of Pd at 39.69% and Cu at 60.31%, while the alloy sample deposited for 2 hours contains 41.78% Pd and 58.22% Cu.

In some embodiment, the metallic ratio of Pd to Cu may be 1:5, 2:5, 3:5, 4:5, 1:2.5 or any values therebetween. In a preferred embodiment, the metallic ratio of Pd to Cu is 1:1.5, consistent with the chemical formula Cu_{0.6}Pd_{0.4}.

In some embodiments, hydrogen evolution reaction (HER) activity may be achieved at high current densities ranging from 10 to 1000 mA/cm², with specific ranges including 10 to 500 mA/cm², 10 to 700 mA/cm², 10 to 300 mA/cm², 10 to 100 mA/cm², 10 to 200 mA/cm², 10 to 400 mA/cm², 10 to 600 mA/cm², and 10 to 750 mA/cm². In a preferred embodiment, the HER activity is achieved with high current densities of 100 and 1000 mA/cm².

In some embodiments, at a current density of 100 mAcm⁻², the catalyst may have an overpotential of 10-100 mV, e.g. 20-100 mV, 10-80 mV, 10-50 mV, 50-100 mV, 10-70 mV, 10-90 mV and 60-100 mV. In a preferred embodiment, at a current density of 100 mA/cm², the catalyst has an overpotential of 64 mV, which is lower than those of pure palladium and pure copper.

In some embodiments, at a current density of 1000 mAcm⁻², the catalyst may have an overpotential of 100-1000 mV, e.g. 200-1000 mV, 100-800 mV, 100-500 mV, 500-1000 mV, 100-700 mV, 100-900 mV and 600-1000 mV. In a preferred embodiment, at a current density of 1000 mA/cm², the catalyst has an overpotential of 137 mV, which is lower than those of pure palladium and pure copper.

In some embodiments, the catalyst may have a Tafel slope of 10-50 mV/dec, e.g. 10 mV/dec, 20 mV/dec, 30 mV/dec, 40 mV/dec, 50 mV/dec or any values therebetween. In a preferred embodiment, the catalyst has a Tafel slope of 28 mV/dec, which is lower than those of pure palladium and pure copper.

In some embodiments, the catalyst may have a surface Gibbs free energy ranging from −0.01 eV to −0.50 eV, e.g. −0.01 eV, −0.05 eV, −0.10 eV, −0.15 eV, −0.20 eV, −0.30 eV, −0.40 eV, −0.50 eV or any values therebetween. In a preferred embodiment, the catalyst has a surface Gibbs free energy of −0.12 eV, which is closer to zero than pure palladium and pure copper.

In some embodiments, the catalyst may have a charge-transfer resistance of 0.01-0.05 Ωcm², e.g. 0.01 Ωcm², 0.02 Ωcm², 0.03 Ωcm², 0.04 Ωcm², 0.05 Ωcm² or any values therebetween. In a preferred embodiment, the catalyst has a charge-transfer resistance of 0.11 Ωcm², which is lower than that of pure palladium and pure copper.

### EXAMPLES

The following examples demonstrate fabrication of binary copper-palladium alloy thin film catalysts for hydrogen evolution performance. The examples are provided solely for illustration and are not to be construed as limitations of the present disclosure, as many variations thereof are possible without departing from the spirit and scope of the present disclosure.

### Example 1: Materials and Methods

Copper (II) acetylacetonate (Cu(C₅H₇O₂)₂, 97%) and palladium (II) acetylacetonate (Pd(C₅H₇O₂)₂), 99%) and solvents (methanol and chloroform) were purchased from Sigma-Aldrich. All chemicals and solvents were used directly in the experiments, without purification.

### Example 2: Deposition of Binary CuPd Alloy and Monometallic Cu and Pd Thin Films

An aerosol-assisted chemical vapor deposition (AACVD) system was utilized for the deposition of thin films of a binary CuPd alloy and monometallic Cu and Pd. Before starting the deposition procedure, graphite strips with dimensions of 1×2 cm² were cleaned using ethanol and acetone solvents. The precursor solution was formulated by dissolving the Cu(acac)₂ (50 mg, 191 mmol and Pd(acac)₂ (58 mg, 191 mmol) in a solvent mixture of toluene/chloroform at a 70:30 volume ratio. The resulting blue color solution was utilized in the AACVD system, and deposition at 475° C. was observed for 1 and 2 hours to fabricate binary CuPd alloy thin films of different microstructural properties. For deposition of monometallic Cu and Pd films, an individual precursor solution of Cu(acac)₂ or Pd(acac)₂ was utilized in AACVD at 475° C.

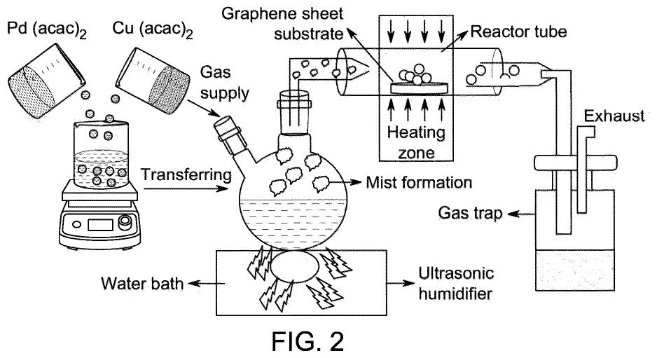

A schematic illustration of thin film fabrication process via AACVD is shown in FIG. 2. A typical AACVD experiment begins with converting a clear binary precursor solution into an aerosol mist using an ultrasonic humidifier. This mist is then directed towards a horizontal tube furnace set at 475° C., containing a quartz tube lined with graphite strips. As the mist enters the heated region, the solvent evaporates, and the gaseous precursor decomposes, releasing products that settle on the graphite surface. Here, nucleation and growth occur, forming a film layer of desired material. The exhaust released is directed into a water trap for disposal. In this process, mist transfer and decomposition happen in the presence of a carrier gas consisting of 5 vt. % of H₂ balanced with 95 vt. % of N₂ (99.999% purity) flowing at a rate of 100 centimeter cube per minute (cm³/min). Deposition is halted after either 1 or 2 hours, with the aerosol supply and furnace shut off subsequently. The furnace is then cooled to room temperature under the flow of an inert gas. The CuPd alloys exhibit a dull grey hue, with films uniformly and securely adhered to the graphite sheet, showing no signs of damage or cracking.

### Example 3: Structural Characterization

The XRD patterns of fabricated thin films were measured in the 2θ range of 20°-90° using an X-ray diffractometer (MiniFlex, Rigaku, Japan). Microstructure and morphological investigations of fabricated thin films were conducted with scanning electron microscopy (SEM, MIRA3, TESCAN). Thin film elemental composition was determined using energy-dispersive X-ray spectroscopy (energy dispersive x-ray (EDX), INCA Energy 200, Oxford Instruments, UK). The chemical states and electronic structure of the film elements were investigated with X-ray photoelectron spectroscopy (XPS, Thermo Scientific ESCALAB 250Xi, USA) with an Al Kα (1486.6 eV) source.

### Example 4: Electrochemical Measurements

All electrochemical experiments were conducted using a Gamry potentiostat (Model No: INTERFACE 1010 E). A standard three-electrode system was employed for detailed manipulations, following the procedures outlined in the present disclosure.

Electrochemical tests were performed using a Gamry potentiostat (Model No: INTERFACE 1010 E). A typical three-electrode system including working (as-fabricated CuPd film), reference (Ag/AgCl), and counter (graphite rod) electrodes immersed in 0.5 M H₂SO₄ was used for all measurements. All the measured potentials were normalized with respect to an RHE, as reported in the literature. Activation of catalysts was achieved with cyclic voltammetry (CV) test performed at a scan rate of 50 mVs⁻¹. The HER parameters (overpotential and current density) were analyzed via linear sweep voltammetry (LSV) at a scan rate of 2 mVs⁻¹. A Tafel plot was obtained from the polarization curve using the following equation:

$$η = b Log j + a , \qquad ( Eq . 1 )$$

where b is the Tafel slope, and a is a constant.

The turnover frequency (TOF) was estimated using the following equation and the comparison of the HER performance conducted in 1.0 M H₂SO₄ electrolyte of various Pd based electrocatalysts synthesized via different methods is shown in Table 1.

$$TOF = \frac{j \times A}{4 \times F \times m} \qquad ( Eq . 2 )$$

Electrochemical impedance spectroscopy (EIS) was performed in the frequency range of 105 to 0.1 Hz at an applied potential of −300 mV.

The electrochemically active surface area (ECSA) was calculated using the following formula:

$$ECSA = {C}_{d 1} / {C}_{s} \qquad ( Eq . 3 )$$

To determine the double-layer capacitance (C_{dl}), CV curves in the non-Faradic range were recorded at different scan speeds (10-60 mVs⁻¹). The ECSA was obtained by dividing the C_{dl} by the specific capacitance (Cₛ) of the electrode, as given by Eq. 3. The average specific capacitance in H₂SO₄ solution for metal electrodes is considered as 0.035 mFcm⁻² in the study [C. C. McCrory, J. Suho, I. M. Ferrer, S. M. Chatman, J. C. Peters and T. F. Jaramillo “Benchmarking hydrogen evolving reaction and oxygen evolving reaction electrocatalysts for solar water splitting devices.” J. Am. Chem. Soc. 2015, 137, 4347-4357, incorporated herein by reference in its entirety].

TABLE 1
Comparison of the HER performance conducted in 1.0M H₂SO₄ electrolyte
of various Pd based electrocatalysts synthesized via different methods

| | | | | Tafel | |
|---|---|---|---|---|---|
| Catalysts | Synthesis route | Substrate | Overpotential | Slope | Ref. |
| PdCo@CN | MOF annealing | GCE | 80 | 31 | A |
| PdₓCu₁₀₀₋ₓ/C | one-pot synthesis | GCE | 102 | 48 | B |
| Pd/Bi/Cu HNAs | electrodeposition | GCE | 79 | 61 | C |
| PdCu NPs/SBA- | Solution processing | carbon | 150 | 45 | D |
| 15-MWCNT | | paste | | | |
| | | electrode | | | |
| Pt@Pd | one-pot synthesis | GCE | 56 | 39 | E |
| PdTe | hydrothermal | GCE | 97 | 90 | F |
| | method | | | | |
| | followed by | | | | |
| | reduction | | | | |
| PdNi NWs | template-confined | GCE | 91 | 96 | G |
| | electrodeposition | | | | |
| PdCo@N—C/ | MOF/graphene | GCE | 87 | 66 | H |
| rGO | oxide | | | | |
| | pyrolysis | | | | |
| Cu_{0.6}Pd_{0.4}-2 h | AACVD | Graphite | 20 | 28 | Present |
| | | sheet | | | disclosure |

A: J. Chen, G. Xia, P. Jiang, Y. Yang, R. Li, R. Shi, R, R. Shi, J. Su and Q. Chen “Active and durable hydrogen evolution reaction catalyst derived from Pd-doped metal-organic frameworks” ACS Appl. Mater. Interfaces 2016, 8, 13378-13383, incorporated herein by reference in its entirety.
B: X. Zhang, W. Dengfeng and D. Cheng “Component-dependent electrocatalytic activity of PdCu bimetallic nanoparticles for hydrogen evolution reaction.” Electrochim. Acta 2017, 246, 572-579, incorporated herein by reference in its entirety.
C: L. Zheng, Z. Shizheng, W. Hongrui, L. Du, Z. Zhu, J. Chen, and D. Yang. “Palladium/bismuth/copper hierarchical nano-architectures for efficient hydrogen evolution and stable hydrogen detection.” ACS Appl. Mater. Interfaces 2019, 11, 6248-6256, incorporated herein by reference in its entirety.
D: E. Chiani, S. N. Azizi, and S. Ghasemi “PdCu bimetallic nanoparticles decorated on ordered mesoporous silica (SBA-15)/MWCNTs as superior electrocatalyst for hydrogen evolution reaction.” Int. J. Hydrogen Energy 2021, 46, 25468-25485, incorporated herein by reference in its entirety.
E: X-X Lin, A-J. Wang, K-M. Fang, J. Yuan, and J.-Ju Feng “One-pot seedless aqueous synthesis of reduced graphene oxide (rGO)-supported core-shell Pt@ Pd nanoflowers as advanced catalysts for oxygen reduction and hydrogen evolution.” ACS Sustain. Chem. Eng. 2017, 5, 8675-8683, incorporated herein by reference in its entirety.
F: L. Jiao, L. Feng, L. Xinzhe, R. Ren, J. Li, X. Zhou, J. Jin, and R. Li “Ultrathin PdTe nanowires anchoring reduced graphene oxide cathodes for efficient hydrogen evolution reaction.” Nanoscale 2015, 7, 18441-18445, incorporated herein by reference in its entirety.
G: L. Du, D. Feng, X. Xing, C. Wang, G. S. Armatas, and D. Yang “Uniform palladium-nickel nanowires arrays for stable hydrogen leakage detection and efficient hydrogen evolution reaction”. Chem. Eng. J. 2020, 400, 125864, incorporated herein by reference in its entirety.
H: M. Zhong, L. Lingling, K. Zhao, F. He, B. Su, and D. Wang. (2021). “PdCo alloys@ Ndoped porous carbon supported on reduced graphene oxide as a highly efficient electrocatalyst for hydrogen evolution reaction” J. Mater. Sci. 2021, 56, 14222-14233, incorporated herein by reference in its entirety.

### Example 5: Computational Methodology

The Vienna ab initio simulation package (VASP) was utilized to perform first-principles calculations on the structural, electronic and catalytic activities of Cu, Pd and binary CuPd alloy using the projected-augmented wave (PAW) technique (G. Kresse and D. Joubert, Physical review b, 1999, 59, 1758, incorporated herein by reference in its entirety). The RPBE exchange-correlation functional was employed at the generalized gradient approximation (GGA) for all the calculations on periodically repeated metal slabs (H. Peng and J. P. Perdew, Physical Review B, 2017, 95, 081105, incorporated herein by reference in its entirety). The valence electron wave functions were expanded using a plane wave basis that had a cutoff kinetic energy of 400 eV. A conjugate-gradient technique was utilized to enhance the lattice constant as well as the atomic coordinates of all structures. The relaxation process continued until the Hellmann-Feynman forces acting on all atoms were below 0.01 electronvolt per angstrom (eV/Å) and the total energy was less than 10⁻⁵ eV. The two-dimensional Brillouin zone was sampled by a Monkhorst-Pack method with 3×3×1 k-points (H. J. Monkhorst and J. D. Pack, Physical review B, 1976, 13, 5188, incorporated herein by reference in its entirety). In order to prevent interactions between periodic images, a vacuum layer with a thickness of 15 (angstrom) Å was added in the z-direction of all structures. The catalytic activity of Pd, Cu and PdCu alloy was assessed using the Gibbs free energy change, which serves as a typical descriptor for the rate of the overall process. Gibbs free energy of hydrogen on a catalyst can be expressed as

$$Δ {G}_{{H}^{*}} = Δ {E}_{H} + Δ {E}_{Z P B} - T Δ {S}_{H} \qquad ( Eq . 4 )$$

where ΔE_{H} is the energy difference of the adsorbed hydrogen atom on catalyst surface, clean surface and molecular hydrogen, ΔE_{ZPE} is the difference in zero point energy between adsorbed and the gaseous hydrogen, T is the temperature, and ΔS_{H} is the corresponding change of entropy. ΔE_{ZPE} was obtained by frequency analysis followed by geometry processing, whereas ΔS_{H} is the half of the entropy of molecular hydrogen in gas phase at standard conditions. At T=298.15 K, ΔE_{ZPE}−TΔS_{H} in equation (4) was estimated to be ˜0.24 eV.

### Results and Discussion

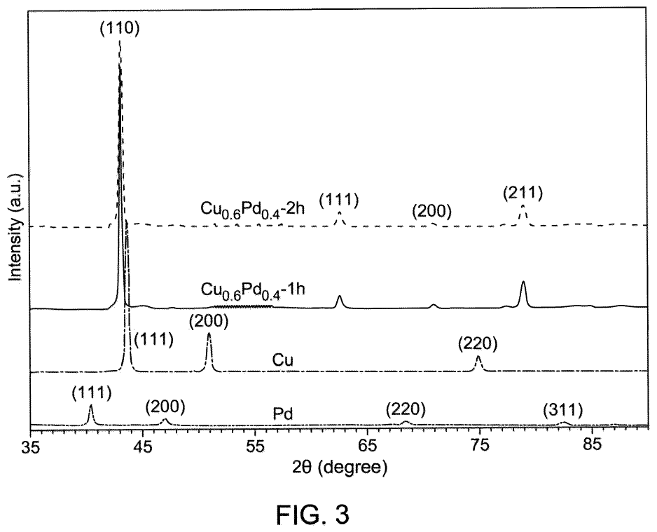

The crystalline structure of thin films of monometallic Cu, monometallic Pd and binary CuPd alloys was analyzed using XRD. The high crystalline peaks of graphite substrate were eliminated to ensure an accurate phase analysis of the crystalline products. FIG. 3 shows the comparative XRD patterns of pure metals and their binary alloy samples deposited for 1 h and 2 h time periods. Pure Pd exhibits four crystalline peaks at 2θ=40.0°, 46.5°, 68.2°, and 82.5°, which can be indexed to the (111), (200), (220), and (311) lattice planes of metallic Pd (ICDD No. 01-088-2335) (M. A. Ehsan, M. H. Suliman, A. Rehman, A. S. Hakeem, Z. H. Yamani and M. Qamar, New Journal of Chemistry, 2020, 44, 7795-7801, incorporated herein by reference in its entirety). While the XRD pattern of metallic Cu explicitly exhibits three crystalline peaks at 2θ=44°, 51.3°, and 75.5°, corresponding to the (111), (200), and (220) planes and indicate the formation of cubic crystal system (ICDD No. 01-071-7832). XRD patterns of binary alloy samples show peaks at 2θ=43.2°, 62.7°, 71.2°, and 70°, which were attributed to the (110), (111), (200), and (211) lattice planes of the single-phased Cu_{0.6}Pd_{0.4} alloy crystallized in the cubic phase (ICDD card No. 01-078-4406) (M. Friedrich and M. Armbrüster, Chemistry of Materials, 2009, 21, 5886-5891, incorporated herein by reference in its entirety). XRD patterns clearly reflect, that high intensity (100%) crystalline peak of bimetallic alloy emerged at larger 2θ value (43.2°) with respect of pure Pd (40°), which suggest the incorporation of Cu atoms into Pd crystal to generate a cubic Cu_{0.6}Pd_{0.4} alloy structure. Crystalline peaks of both alloy samples appeared at same 2θ values, indicating the formation of the similar Cu_{0.6}Pd_{0.4} phase. No other crystalline peaks related to any other possible phase of the CuPd alloy, metallic Pd, Co, or any of their oxide species were observed, confirming the formation of single-phase Cu_{0.6}Pd_{0.4} alloys.

FIGS. 4A-4D illustrate the SEM morphology of binary CuPd alloy and monometallic Cu and Pd grown on a graphite substrate at 475° C. Low-magnification SEM images (20 μm) of FIGS. 4A, 4B, 4C, and 4D witnessed the uniformly grown material covering a large substrate area without breaks or voids. However, at this magnification level, the morphological features remain unrecognizable. The high-resolution images (5 μm) of FIGS. 4A, 4B, 4C, and 4D further elucidate the thin film microstructure and the developed morphological patterns. The binary CuPd alloy deposited for 1 h exhibits structures that extend upward from the plane of the graphite substrate (as shown in FIG. 4A with 5 μm scale). Upon further zooming in a particular object, one can discern the emergence of tower-like structures standing tall in a vertical orientation, adorned with continuous buds reminiscent of a Christmas tree (as shown in FIG. 4A with 1 μm scale). As the deposition time extends to 2 hours, there is a noticeable enhancement in the growth of these vertical structures. This leads to the appearance of clusters of tower-like objects, resembling a skyline seen from a bird's-eye view, with numerous skyscraper-like buildings (as shown in FIG. 4B with 5 μm scale). A magnified view of an individual tower object, it becomes evident that its length exceeds 5 μm, with scales heavily grown on its surface, displaying a lateral perspective of a pine tree.

By contrast, pure metallic Cu and Pd show nanoparticle-like morphology. The magnified images show that the interconnected nanoparticles are undergoing agglomeration, resulting in the formation of large particles. The SEM results demonstrate that vapors of Cu and Pd precursors underwent decomposition and deposition reaction at a high temperature of 475° C., resulting in the formation of a distinctive tower-like microstructure. Such a morphology is rarely observed or not observed in materials synthesized using other solution-based techniques or using other precursors in AACVD. One advantage of the AACVD approach is its ability to grow features directly onto the substrate surface, even without the use of structural directing reagents or templates, all within a short processing time. While developing catalysts for water splitting, the emergence of novel morphological patterns is highly desirable. This facilitates the creation of a high density of reaction sites, exposed to enhance the rates of the HER.

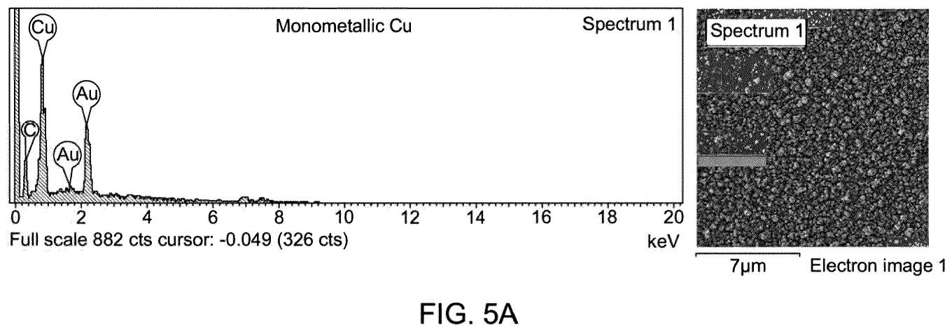

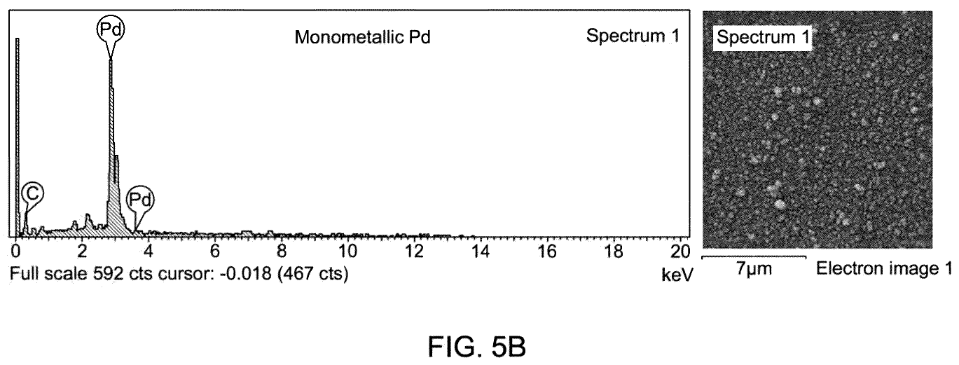

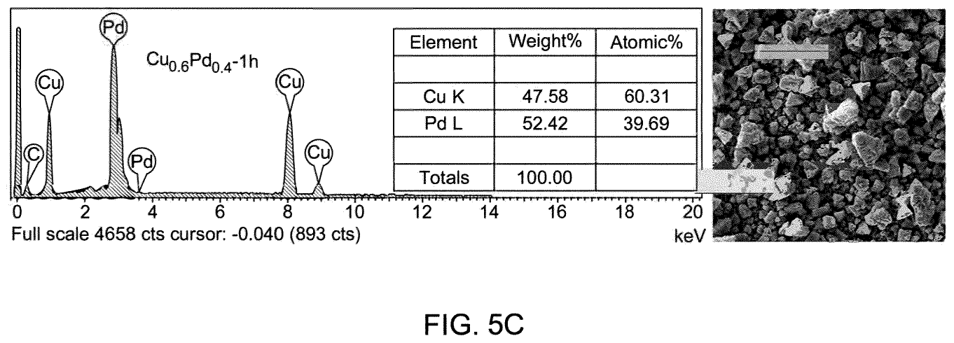

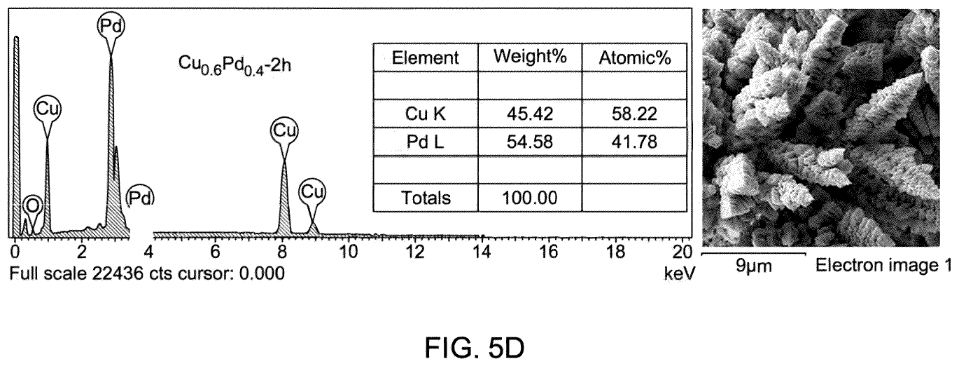

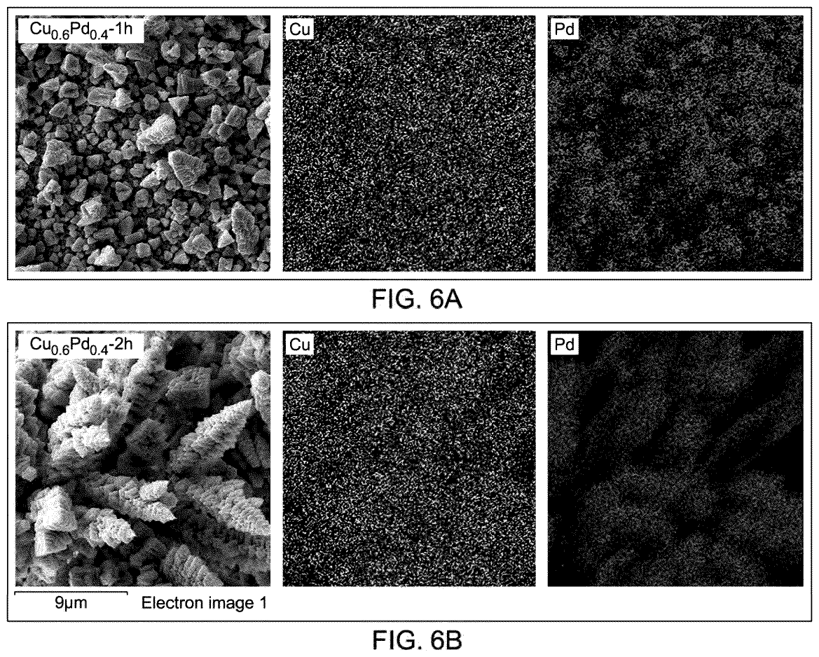

The elemental composition of fabricated thin films was established through EDX analysis, as shown in FIGS. 5A-5D. The monometallic films contained Cu and Pd elements in their individual samples whereas the binary alloy displayed the presence of both elements. The CuPd alloy sample deposited for 1h showed the atomic percent of Pd (39.69 mol. %) and Cu (60.31 mol. %), while the alloy sample deposited for 2 h showed of 41.78 mol. % of Pd and 58.22 mol. % of Cu. Both alloy samples estimate a metallic ratio of Pd to Cu at around 1:1.5, consistent with the chemical formula Cu_{0.6}Pd_{0.4} identified from XRD analysis. In the EDX spectra, there is an absence of an oxygen peak, suggesting the synthesis of pure monometallic and alloy materials and the lack of corresponding metal oxides. Moreover, the EDX mapping of alloy samples confirmed the homogeneous distribution of Pd and Cu elements within the film matrix, as shown in FIGS. 6A-6B.

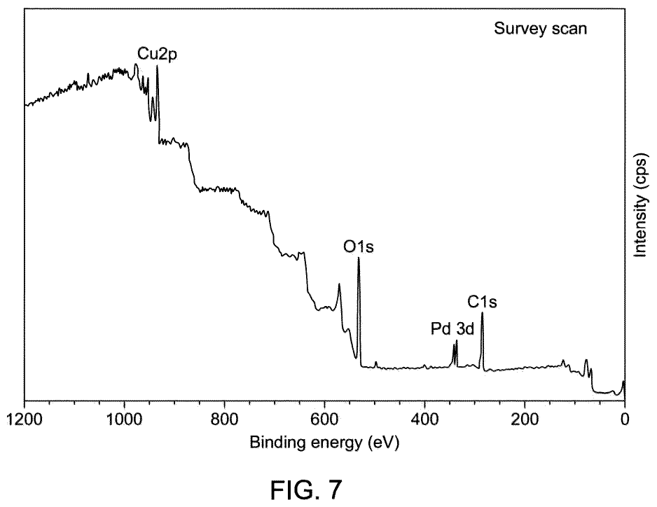

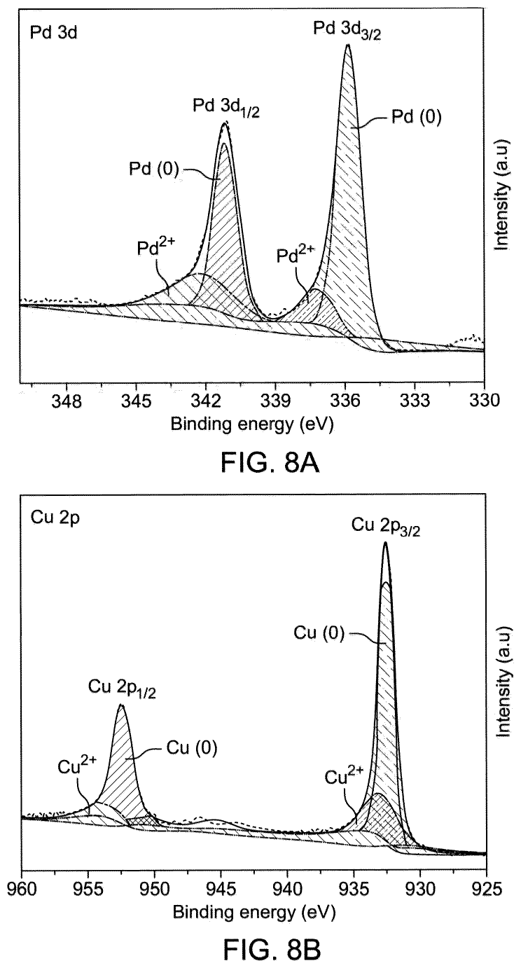

XPS analysis was used to study the chemical states and electronic structure of the key elements involved in Cu_{0.6}Pd_{0.4} alloy fabricated for 2 h. The presence of essential elements of Cu and Pd was recognized with survey scan XPS, as shown in FIG. 7. The high resolution deconvoluted spectrum of Pd 3d showed peaks at binding energies of 335.8 eV (3d_{5/2}) and 341.1 eV (3d_{3/2}), indicating the presence of Pd metal in its zero oxidation (0) state, as shown in FIG. 8A. The relatively small peaks at 337.4 eV and 341.9 eV indicate the existence of Pd²⁺ species due to the inevitable surface oxidation when the sample was exposed to air. Analogously, the Cu 2p XPS spectrum, shown in FIG. 8B, of the Cu_{0.6}Pd_{0.4} alloy, involves two fitted peaks at binding energies of 932.23 eV and 952.08 eV, which respectively correspond to Cu 2p_{3/2} and Cu 2p_{1/2} of metallic Cu (0). The peaks at 933.08 eV and 953.58 eV belong to Cu 2p_{3/2} and Cu 2p_{1/2} of Cu (2+), while 945.28 eV is a satellite peak (C. Wu, J. Zhu, H. Wang, G. Wang, T. Chen and Y. Tan, ACS Catalysis, 2019, 10, 721-735, incorporated herein by reference in its entirety).

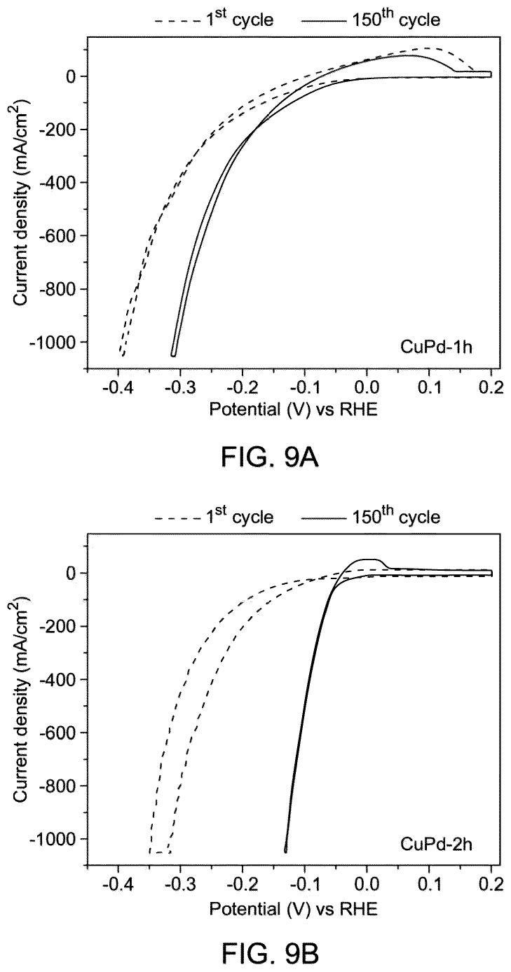

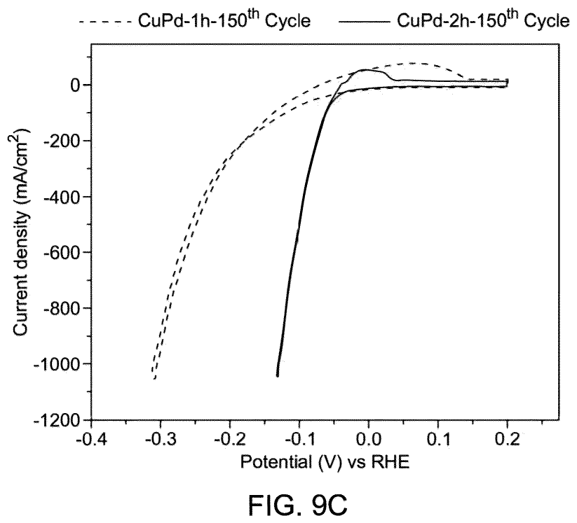

The HER performance of thin film electrocatalysts was assessed into a standard three-electrode setup using 0.5 M H₂SO₄ electrolyte solution. Before measuring the HER activity, the binary CuPd electrocatalyst was activated by consecutive cyclic voltammetry (CV) scans for 150 cycles, until a stable and uniform CV signal was achieved. FIGS. 9A-9B show the CV results of activated electrocatalysts, with the first and 150th CV curves overlaid to show the changes occurring throughout the CV process. For both alloy samples, the 150th CV exhibits a noticeable shift towards lower potentials, suggesting that alloy surfaces achieved activation during CV cycling. A comparison of the final CV curves (150th) reveals that the CuPd deposited for 2 h has undergone greater activation, as evidenced by a more pronounced shift towards lower potentials compared to the 1 h catalyst, as shown in FIG. 9C). This suggests that the tower-like array developed in the CuPd-2 h catalyst offers more catalytically active sites, consequently accelerating the HER rate, as demonstrated by the high peak current density achieved at low overpotentials. Moreover, CV curves show an oxidation peak around 0 V (vs RHE), referring towards the adsorption or desorption of intermediate species on the electrode surface.

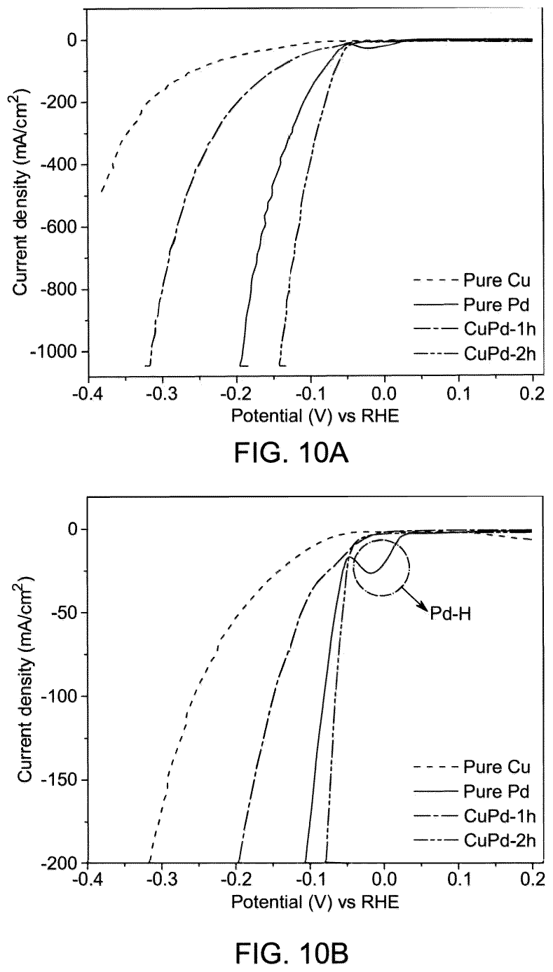

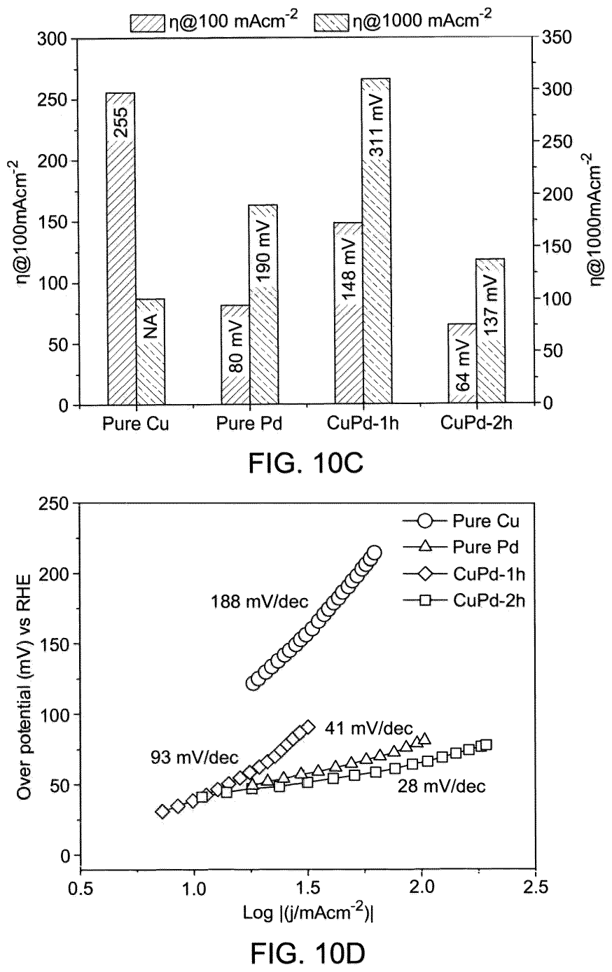

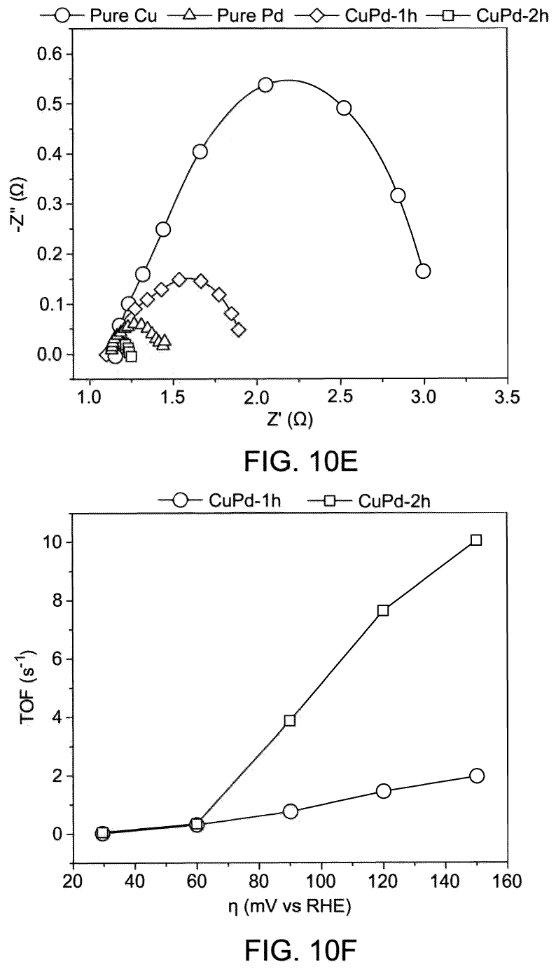

Following the CV test, LSV measurements were conducted at a low-scan rate of 2 mVs⁻¹ to investigate the HER performances of the electrocatalysts. FIG. 10A shows that LSV curves of pure Pd and binary CuPd alloys reaches a significant current density of 1000 mAcm⁻² at varying overpotentials, except that of monometallic Cu, which shows poor performance under the given electrochemical conditions. An enlarged view, as depicted in FIG. 10B, provides further insight into the distinctions among the LSV profiles. The CuPd-2 h shows HER behavior similar to that of pure Pd, while the CuPd-1 h slightly underperforms in comparison. In the case of pure Pd catalyst, a typical Pd—H bond peak is observed around ˜0 V (vs RHE), which is absent in both CuPd alloys, indicating structural modulation in pure Pd when interacted with Cu, ultimately leading to the formation of the Cu—Pd alloys. FIG. 10C illustrates the comparison of overpotentials at different current densities. For instance, at 100 mAcm⁻² the overpotentials increased in the following order: CuPd-2h (64 mV)<pure Pd (80 mV)<CuPd-1h (148 mV)<Cu (255 mV).

Meanwhile, at large current density of 1000 mAcm⁻², CuPd-2 h catalyst needed the lowest overpotential of (137 mV) and outperforms the pure Pd (190 mV), while CuPd-1 h still requires higher overpotential of 311 mV. It is worth noticing that catalytic activity of pure Pd closely resembles that of the benchmark Pt in HER, despite both Pt and Pd being expensive metals. However, by alloying Pd with the more cost-effective Cu, it becomes possible to readily modulate the electronic structure within the resulting Cu—Pd alloy and achieve better catalytic activity than benchmark catalysts. Moreover, the tower-like microstructure engineered in CuPd-2 h alloy offers abundant active sites conducive to enhancing the kinetics of HER. The synergistic interplay between the Cu and Pd metals and the distinctive microstructures not only lowers the overpotential requirements but also augments the HER activity as evidenced by the observed LSV results, as shown in FIG. 10D.

The catalytic attributes of an electrocatalyst can be assessed through its Tafel slope, where a smaller slope generally indicates quicker reaction kinetics. To further explore the HER catalytic mechanism, Tafel slopes were obtained through the plotting of overpotential (η) against the logarithm of the current density (j). The estimated Tafel slope for CuPd-2 h (28 mV dec⁻¹) was smaller than those of pure Pd (41 mV dec⁻¹), CuPd-1 h (93 mV dec⁻¹) and pure Cu (188 mV dec⁻¹), comparable or even better than those of the catalysts previously reported and described in Table 1. The lower Tafel slope of CuPd-2h catalyst indicates that the rate-limiting step is the charge-transfer (Volmer) process, and Volmer-Heyrovsky reaction being the pathway for the HER.

Further, electrochemical impedance spectroscopy (EIS) measurements were conducted to compare the electrical conductivity of different catalysts. FIG. 10E presents a comparative Nyquist plot of all investigated catalysts. The charge-transfer resistance (R_{ct}) was measured to be 0.11 Ωcm², 0.76 Ωcm², 0.32 Ωcm², and 1.87 Ωcm² for CuPd-2h, pure Pd, CuPd-1h and pure Cu, respectively. The far smaller Ret and minute arc size of CuPd-2h catalyst compared with those of pure Pd and the other control catalysts suggests faster charge transfer in the reaction at the catalyst-electrolyte interface. Thus, CuPd-2h exhibited the highest electrical conductivity, which can translate into faster electronic communication and higher HER performance on the electrode surface.

TOF is a valuable indicator for characterizing the intrinsic catalytic activity of different catalysts. The TOF values of CuPd alloys measured at different overpotentials (at η=20 mV, 40 mV, 60 mV, 80 mV, 100 mV, and 120 mV) are shown in FIG. 10F. At an overpotential of 120 mV, the TOFs of CuPd-2h, and CuPd-1h were 7.58 s⁻¹ and 1.75 s⁻¹, respectively. The remarkably higher TOF of CuPd-2h indicates a faster reaction on the catalyst surface under the electrochemical conditions employed.

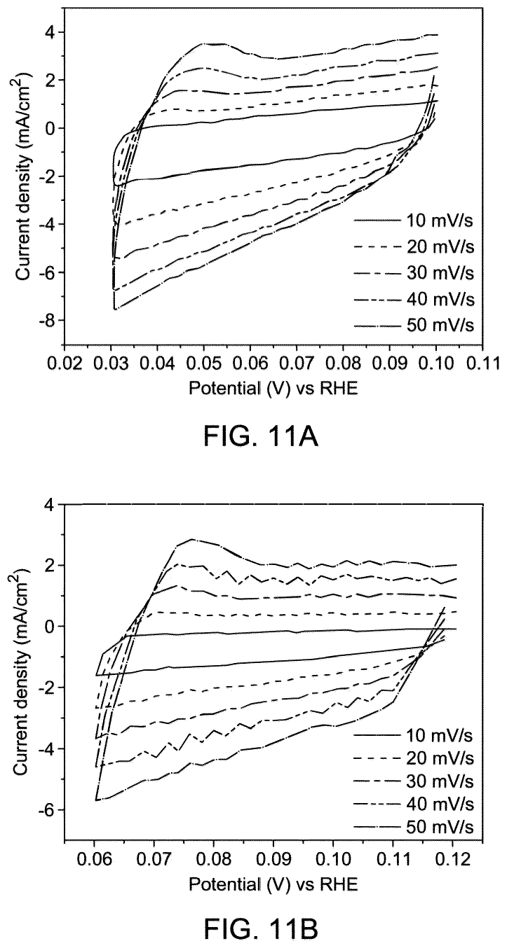

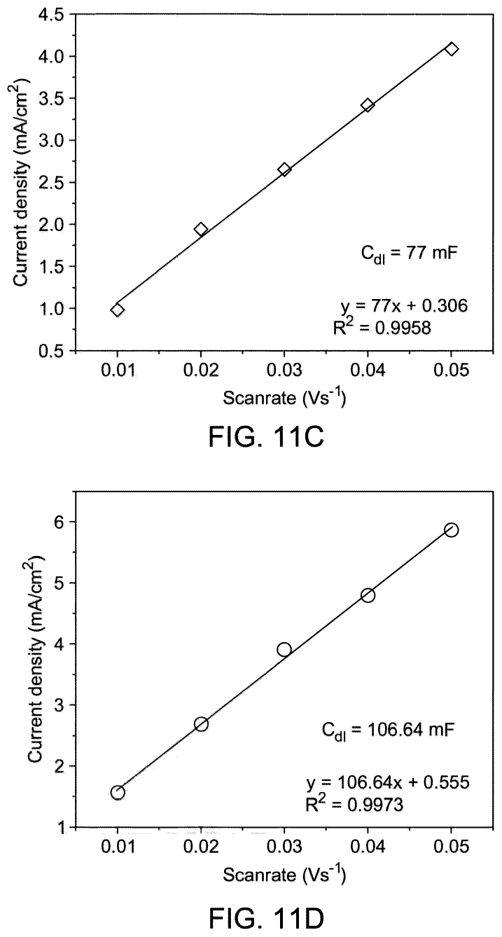

Moreover, ECSA serves as a crucial parameter for identifying catalyst with distinguished catalytic activity. To determine the ECSA, the value of the double-layer capacitance (Cal) is obtained through simultaneous CV measurements in the non-faradaic region at various scan rates ranging from 10 to 60 mV (vs. RHE). FIGS. 11A-11B show the resultant CV curves of binary CuPd alloy catalysts. The Ca value of each catalyst measured by plotting an anodic current density versus a scan rate as shown in FIGS. 11C-11D. According to the calculations, the CuPd-2h alloy delivered a higher Cal (106 mF cm⁻²) than CuPd-1h (77 mF cm⁻²). The ECSA of the CuP-2h catalyst, which was as high as 3046 cm², indicated that more accessible active sites were formed on its surface compared with the other CuPd-1h (2200 cm²) catalyst.

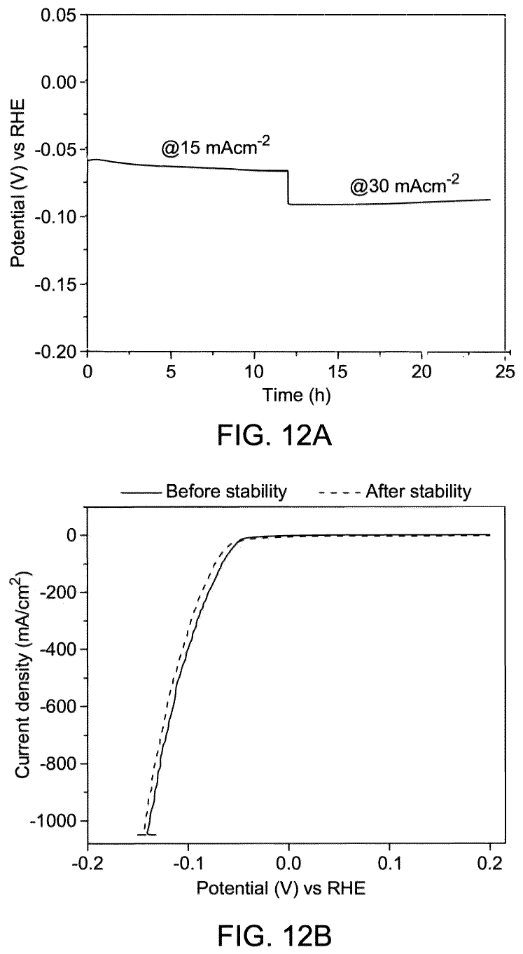

In addition to demonstrating outstanding catalytic activity, it is important for catalysts to exhibit robust electrochemical stability, to verify its suitability for large-scale applications. Therefore, a chronopotentiometric test was conducted using the CuPd-2h catalyst to evaluate its long-term stability for HER catalysis in a 0.5 M H₂SO₄ solution. FIG. 12A demonstrates the efficient performance of the catalyst under two different applied current densities, 15 and 30 mAcm⁻², over a continuous 24-hour period, showing no notable decay in potential signals, thus indicating the durability of the system for the HER under the employed electrochemical conditions. After the stability test, the HER activity was again measured with LSV polarization curve. FIG. 12B shows comparable j-V responses before and after the 24-h long stability test, indicating the sustainable HER performance of the alloy catalyst.

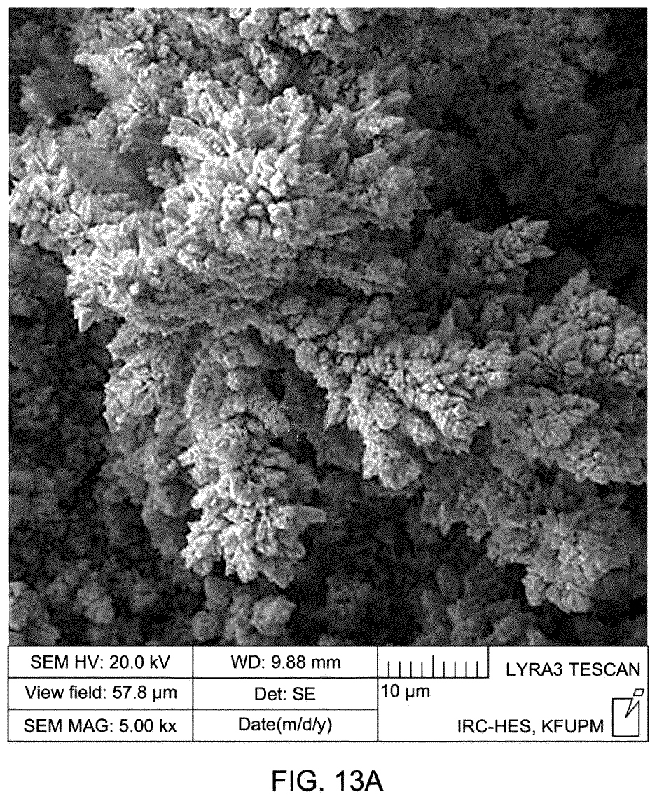

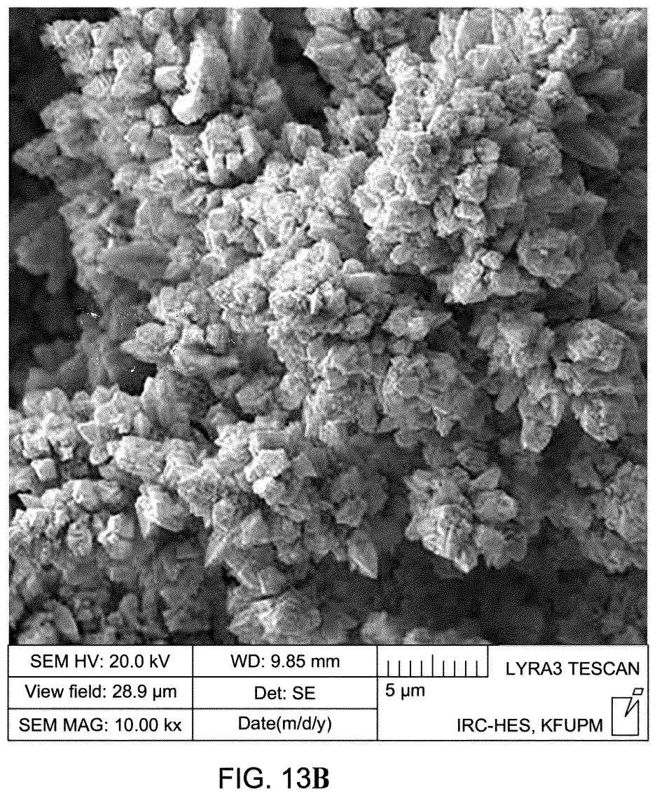

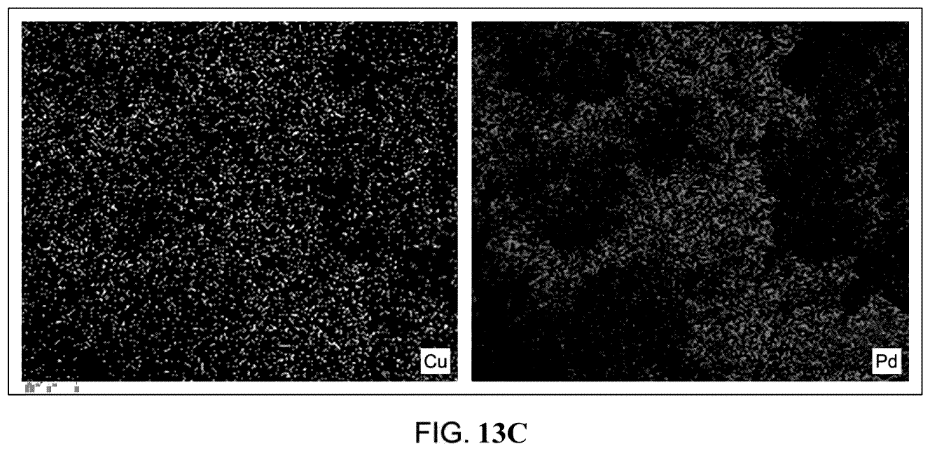

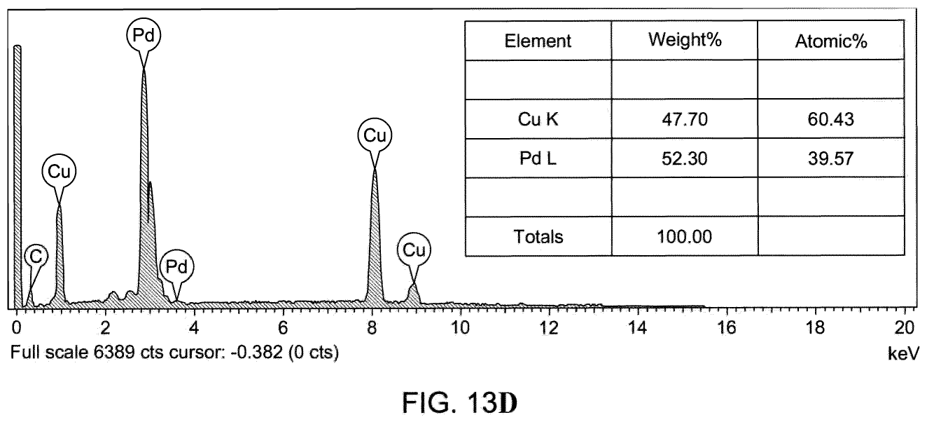

Subsequent to the chronopotentiometric test, the surface of the CuPd-2h binary catalyst was reassessed using SEM and EDX to characterize potential morphological and compositional modifications, as shown in FIGS. 13A-13D. The tower shape is slightly crumbled due to the influence of acid electrolytes throughout continuous HER measurements (FIGS. 13A-13C). Additionally, EDX analysis determined the elemental concentrations of Pd and Cu to be 46.9 mol. % and 53.1 mol. %, respectively, resulting in an empirical molar ratio of 1:1.5. This ratio corresponds to that of the originally synthesized Cu_{0.6}Pd_{0.4}-2h catalyst. Furthermore, EDX mapping, as shown in FIG. 13D demonstrated that the catalyst retained elemental uniformity between Cu and Pd elements, even following a 24-hour stability test conducted in an acidic electrolyte. Overall, the post-characterization findings suggest that the binary catalyst effectively preserved its structural and compositional integrity throughout the electrochemical HER investigations conducted in a 0.5 M H₂SO₄ electrolyte. Consequently, the binary Cu_{0.6}Pd_{0.4}-2h alloy electrocatalyst, deposited onto a graphite substrate via AACVD, demonstrated notable HER activity and durability.

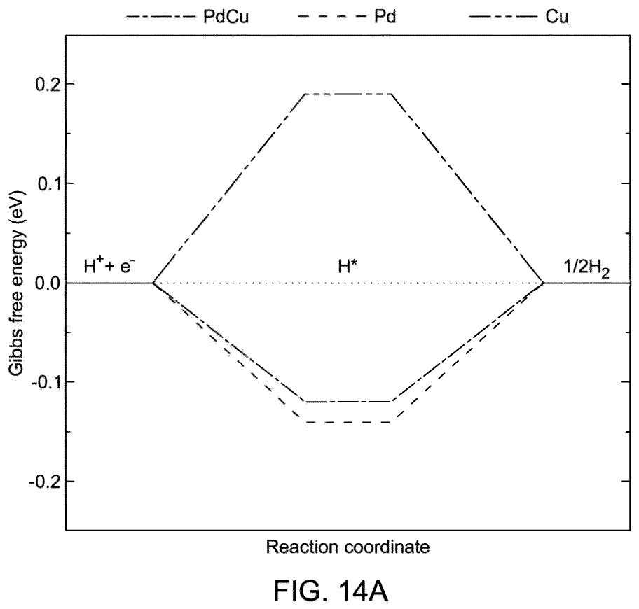

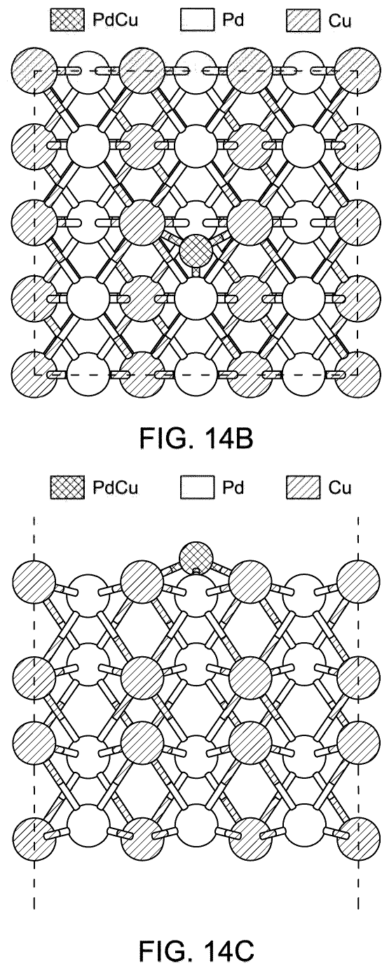

In order to compare the electrocatalytic performance of monometallic Cu, Pd and binary CuPd alloy, a series of comprehensive DFT calculations were conducted. The atomic structure of the as-synthesized CuPd alloy along with (110) plane was selected and processed prior to measuring the catalytic activity calculations. The XRD results of bulk CuPd alloy exhibited cubic crystal structure, a space group of Pm³⁻m and a lattice constant of 2.98 Å. Therefore, the bulk structure was cleaved into a (110) surface to conduct HER calculations. For an efficient HER catalyst, the Gibbs free energy change should be nearly zero. DFT calculations revealed a clear difference in the hydrogen adsorption energies between CuPd alloy (−0.36 eV) and monometallic Pd (−0.38 eV) and Cu (−0.05 eV). On the surfaces of Pd and Cu crystals, the Gibbs free energy of a hydrogen atom are calculated to be −0.14 eV and 0.19 eV, respectively. However, the Gibbs free energy for the CuPd surface is −0.12 eV, which is closer to zero than that of Pd or Cu, as shown in FIG. 14A. The calculated Gibbs free energy suggests that the adsorbed hydrogen does not exhibit excessively weak or strong binding to the CuPd surface. This characteristic boosts the surface's activity in the HER. During the process of processing the geometry of hydrogen adsorbed on the Pd (Cu) surface, it was seen that the hydrogen atom formed bonds with three neighboring Pd (Cu) atoms on the surface. Similarly, hydrogen adsorbed on the CuPd surface formed bonds with one Pd and two neighboring Cu atoms, as shown in FIGS. 14B-14C. The bond lengths of Pd—H and Cu—H are measured to be 1.72 Å and 1.79 Å, respectively, suggesting more active interaction of H with Pd compared to that of Cu.

The Bader charge calculations demonstrated that the addition of Cu to the Pd structure caused a redistribution of charges between the Pd and Cu atoms in the alloy, due to the difference in their electronegativities. This redistribution of charges contributed to a better understanding of the catalytic activity of Cu and Pd in the binary CuPd alloy. The charge redistribution in CuPd enhances the catalytic activity of Pd in the alloy by reducing the Gibbs free energy from −0.14 to −0.12 eV, in comparison to intrinsic Pd surface. Barder charge analysis indicates that Pd acquired a 0.2e from Cu, leading to an increase in catalytic activity of Pd in the alloy. The combination of experimental data and DFT calculations conclusively shows that the formation of CuPd alloy greatly improves the HER compared to its constituent materials.

According to the present disclosure, the AACVD process has been successfully employed to produce thin films of binary Cu—Pd and monometallic Cu and Pd on graphite sheets, using readily available acetylacetonate compounds of Cu and Pd. These fabricated film electrocatalysts have been assessed for their efficacy in promoting the HER reaction under acidic conditions. The binary Cu_{0.6}Pd_{0.4} electrocatalyst, deposited for 2 hours, exhibited a distinctive microstructure resembling a cluster of towers and demonstrated remarkable performance, surpassing even benchmark catalysts such as Pt and Pd, thereby substantially reducing the cost associated with noble metal catalysts. Detailed electrochemical analyses unveiled that the binary alloy catalyst required relatively small overpotentials of 64 and 137 mV at current densities of 100 and 1000 mAcm⁻², respectively, along with faster Tafel kinetics (28 mV dec⁻¹) and sufficient catalytic stability over 24 hours. The enhanced catalytic activity is attributed to the synergistic interactions facilitated between the noble-transition metal (Cu—Pd) and the abundance of active sites provided by the thin film structure. Both of these factors significantly contribute to the improved catalytic activity and stability of the binary alloy catalysts. These experimental results have been verified 5 by DFT calculations, revealing the enhanced catalytic efficiency of the binary CuPd alloy (−0.12 eV) compared to monometallic Pd (−0.14 eV) and Cu (0.19 eV).

Numerous modifications and variations of the present disclosure are possible in light of the above teachings. It is therefore to be understood that within the scope of the appended claims, the invention may be practiced otherwise than as specifically described herein.

1. A catalyst, comprising:
a graphite substrate; and
a thin film of copper-palladium alloy disposed on the graphite substrate, wherein the copper-palladium alloy conforms to a formula of Cu₁₋ₓPdₓ, where x is about 0.4,
the thin film includes conical structures that have a length of 1-20 μm, and
the conical structures have a pine-tree shape that has tiers of sheet-like branches.

2. The catalyst of claim 1, wherein:
the tiers are stacked in a longitudinal direction of the pine-tree shape,
the sheet-like branches are substantially perpendicular to the longitudinal direction of the pine-tree shape, and
each tier includes a respective plurality of sheet-like branches arranged adjacent to each other.

3. The catalyst of claim 2, wherein:
the sheet-like branches decrease in lateral dimensions along the longitudinal direction of the pine-tree shape from a wide end of the pine-tree shape to a narrow end of the pine-tree shape.

4. The catalyst of claim 3, wherein:
the sheet-like branches are arranged in a whorled pattern, when viewed from the narrow end of the pine-tree shape.

5. The catalyst of claim 3, wherein:
the narrow end of the pine-tree shape is a sharp point or a single smallest sheet-like branch.

6. The catalyst of claim 3, wherein:
the narrow end of the pine-tree shape has a lateral dimension of 0.5 μm or less, and
the wide end of the pine-tree shape has a lateral dimension of 1 μm or more and 10 μm or less.

7. The catalyst of claim 1, wherein:
the thin film consists of a single-phase Cu₁₋ₓPdₓ alloy and includes no metallic copper and no metallic palladium.

8. The catalyst of claim 7, wherein:
the thin film includes no copper oxide and no palladium oxide.

9. The catalyst of claim 1, wherein:
the conical structures are oriented randomly on the graphite substrate.

10. The catalyst of claim 1, wherein:
one or more of the conical structures are oriented perpendicular to the graphite substrate

11. The catalyst of claim 1, wherein:
the catalyst has an overpotential of 64 mV at a current density of 100 mAcm⁻², which is lower than those of pure palladium and pure copper.

12. The catalyst of claim 1, wherein:
the catalyst has an overpotential of 137 mV at a current density of 1000 mAcm⁻², which is lower than those of pure palladium and pure copper.

13. The catalyst of claim 1, wherein:
the catalyst has a Tafel slope of 28 mV/dec, which is lower than those of pure palladium and pure copper.

14. The catalyst of claim 1, wherein:
the catalyst has a surface Gibbs free energy of −0.12 eV, which is closer to zero than those of pure palladium and pure copper.

15. The catalyst of claim 1, wherein:
the catalyst has a charge-transfer resistance of 0.11 Ωcm², which is lower than those of pure palladium and pure copper.

16. The catalyst of claim 1, wherein the catalyst is formed by executing an aerosol-assisted chemical vapor deposition (AACVD) process that comprises:
converting a precursor solution into an aerosol mist by an ultrasonic humidifier, the precursor solution comprising copper acetylacetonate and palladium acetylacetonate,
directing the aerosol mist towards a graphite substrate placed in a furnace by a carrier gas containing hydrogen and nitrogen, and
maintaining the graphite substrate at a temperature of 450° C.-550° C. to evaporate a solvent of the aerosol mist, decompose the copper acetylacetonate and the palladium acetylacetonate, and form the thin film on the graphite substrate to form the catalyst.

17. An electrode, comprising:
the catalyst of claim 1; and
no binder.

18. A method of preparing a catalyst, comprising:
executing an aerosol-assisted chemical vapor deposition (AACVD) process that comprises:
converting a precursor solution into an aerosol mist by an ultrasonic humidifier, the precursor solution comprising copper acetylacetonate and palladium acetylacetonate,
directing the aerosol mist towards a graphite substrate placed in a furnace by a carrier gas containing hydrogen and nitrogen, and
maintaining the graphite substrate at a temperature of 450° C.-550° C. so as to evaporate a solvent of the aerosol mist, decompose the copper acetylacetonate and the palladium acetylacetonate, and form a thin film of copper-palladium alloy on the graphite substrate to form a catalyst including the thin film and the graphite substrate; and
using the catalyst directly as an electrode without binding to another support surface or electrode surface.

19. The method of claim 18, wherein:
no structural directing reagent or template is used for forming the thin film of copper-palladium alloy on the graphite substrate.

20. The method of claim 18, wherein:
a deposition time of the AACVD process is at least 2 hours, and
the temperature, at which the graphite substrate is maintained, is about 475° C.
